(19) United States
(12) Patent Application Publication
(10) Pub. No.: US 2024/0053463 A1
(43) Pub. Date: Feb. 15, 2024

(54) METHODS AND APPARATUSES FOR LATENCY REDUCTION IN GESTURE RECOGNITION USING MMWAVE RADAR

(71) Applicant: Samsung Electronics Co., Ltd., Suwon-si (KR)

(72) Inventors: Saifeng Ni, Santa Clara, CA (US); Vutha Va, Plano, TX (US); Priyabrata Parida, Garland, TX (US); Anum Ali, Plano, TX (US); Boon Loong Ng, Plano, TX (US)

(21) Appl. No.: 18/174,602

(22) Filed: Feb. 24, 2023

Related U.S. Application Data
(60) Provisional application No. 63/396,846, filed on Aug. 10, 2022.

(51) Int. Cl. G01S 13/62; G06F 3/01; G01S 7/28

(52) U.S. Cl. CPC G01S 13/62; G06F 3/017; G01S 7/2813

(57) ABSTRACT

A method includes obtaining a stream of radar data into a sliding input data window composed of recent radar frames from the stream. Each radar frame within the data window includes features selected from a predefined feature set and at least one of time-velocity data or time angle data. The method includes, for each radar frame within the data window, receiving a binary prediction indicating whether the radar frame includes a gesture end. The method includes in response to the binary prediction indicating that the radar frame includes the gesture end, triggering an early stop (ES) checker to determine whether an ES condition is satisfied. Determining whether the ES condition is satisfied comprises determining whether a noise frames condition and a valid activity condition are satisfied. The method includes in response to a determination that the ES condition is satisfied, triggering a gesture classifier to predict a gesture type.

### CROSS-REFERENCE TO RELATED APPLICATION(S) AND CLAIM OF PRIORITY

This application claims priority under 35 U.S.C. § 119(e) to U.S. Provisional Patent Application No. 63/396,846 filed on Aug. 10, 2022. The above-identified provisional patent application is hereby incorporated by reference in its entirety.

### TECHNICAL FIELD

This disclosure relates generally to radar systems. More specifically, this disclosure relates to methods for latency reduction in gesture recognition using mmWave radar.

### BACKGROUND

Voice and gestural interactions are becoming increasingly popular in the context of ambient computing. These input methods allow the user to interact with digital devices (for example, smart televisions, smartphones, tablets, smart home devices, AR/VR glasses, etc.) while performing other tasks, such as cooking and dining. Gestural interactions can be more effective than voice, particularly for simple interactions such as snoozing an alarm or controlling a multimedia player. For such simple interactions, gestural interactions have two main advantages compared to voice-based interactions, namely, complication and social-acceptability. First, the voice-based commands can often be long, and the user has to initiate with a hot word. Second, in quiet places and during conversations, the voice-based interaction can be socially awkward.

Gestural interaction with a digital device can be based on different sensor types (for example, ultrasonic, IMU, optic, and radar). Optical sensors give the most favorable gesture recognition performance. The limitations of optic sensor based solutions, however, are sensitivity to ambient lighting conditions, privacy concerns, and battery consumption. Hence, optic sensor based solution have the inability to run for long periods of time. LIDAR based solutions can overcome some of these challenges such as lighting conditions and privacy, but the cost is still prohibitive (currently, only available in high-end devices).

### SUMMARY

This disclosure provides methods for latency reduction in gesture recognition using mmWave radar.

In one embodiment, a method for reducing latency in gesture recognition by a mmWave radar system is provided. The method includes obtaining a stream of radar data into a sliding input data window that is composed of recent radar frames from the stream. Each radar frame within the data window includes features selected from a predefined feature set and at least one of time-velocity data (TVD) or time angle data (TAD). The method includes, for each radar frame within the data window, receiving a binary prediction indicating whether the radar frame includes a gesture end. The method includes in response to the binary prediction indicating that the radar frame includes the gesture end, triggering an early stop checker to determine whether an early stop condition is satisfied. Determining whether the early stop condition is satisfied comprises determining whether a noise frames condition and a valid activity condition are satisfied. The method includes in response to a determination that the early stop condition is satisfied, triggering a gesture classifier (GC) to predict a gesture type.

In another embodiment, an electronic device for reducing latency in gesture recognition by a mmWave radar system is provided. The electronic device includes a transceiver and a processor operatively connected to the transceiver. The processor is configured to obtain a stream of radar data into a sliding input data window that is composed of recent radar frames from the stream. Each radar frame within the data window includes features selected from a predefined feature set and at least one of time-velocity data (TVD) or time angle data (TAD). The processor is configured to for each radar frame within the data window, receive a binary prediction indicating whether the radar frame includes a gesture end. The processor is configured to for in response to the binary prediction indicating that the radar frame includes the gesture end, trigger an early stop checker to determine whether an early stop condition is satisfied. To determine whether the early stop condition is satisfied, the processor is further configured to determine whether a noise frames condition and a valid activity condition are satisfied. The processor is configured to in response to a determination that the early stop condition is satisfied, trigger a gesture classifier (GC) to predict a gesture type.

In yet another embodiment, a non-transitory computer readable medium comprising program code for reducing latency in gesture recognition by a mmWave radar system is provided. The computer program includes computer readable program code that when executed causes at least one processor to obtain a stream of radar data into a sliding input data window that is composed of recent radar frames from the stream. Each radar frame within the data window includes features selected from a predefined feature set and at least one of time-velocity data (TVD) or time angle data (TAD). The computer readable program code causes the processor to for each radar frame within the data window, receive a binary prediction indicating whether the radar frame includes a gesture end. The computer readable program code causes the processor to in response to the binary prediction indicating that the radar frame includes the gesture end, trigger an early stop checker to determine whether an early stop condition is satisfied. Determining whether the early stop condition is satisfied comprises determining whether a noise frames condition and a valid activity condition are satisfied. The computer readable program code causes the processor to in response to a determination that the early stop condition is satisfied, trigger a gesture classifier (GC) to predict a gesture type.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Definitions for other certain words and phrases may be provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example communication system in accordance with an embodiment of this disclosure;

FIG. 2 illustrates an example electronic device in accordance with an embodiment of this disclosure;

FIG. 3 illustrates a three-dimensional view of an example electronic device that includes multiple millimeter wave (mmWave) antenna modules in accordance with an embodiment of this disclosure;

FIG. 4 illustrates an example architecture of a monostatic radar in an electronic device 400 in accordance with an embodiment of this disclosure;

FIG. 5 illustrates a mmWave monostatic frequency-modulated continuous wave (FMCW) transceiver system in accordance with an embodiment of this disclosure;

FIG. 6 illustrates a frame-based radar transmission timing structure in accordance with an embodiment of this disclosure;

FIG. 7 illustrates a radar-based end-to-end gesture recognition system in accordance with an embodiment of this disclosure;

FIG. 8 illustrates a gesture set that forms a gesture vocabulary in accordance with an embodiment of this disclosure;

FIG. 9 illustrates an example end-detection method executed by the ADM in accordance with an embodiment of this disclosure;

FIG. 10 illustrates a fixed-duration accumulator algorithm implemented as part of the end-detection method of FIG. 9 in accordance with an embodiment of this disclosure;

FIGS. 11A, 11B, and 11C illustrate a prediction of an end of a gesture as determined by a binary classifier based on various examples of a time-velocity data (TVD) in accordance with an embodiment of this disclosure;

FIG. 12 illustrates an early stop checker within an end-detection method executed by an ADM in accordance with an embodiment of this disclosure;

FIG. 13 illustrates a method of an early stop checker in accordance with an embodiment of this disclosure;

FIGS. 14A, 14B, and 14C illustrate various examples of a data window of radar data that includes a gesture with different types of ends of a gesture, in accordance with an embodiment of this disclosure;

FIG. 15 illustrates extracted features including TVD and TAD for the same period of time, which includes a data window 1522 of radar data, in accordance with an embodiment of this disclosure;

FIG. 16 illustrates a histogram of power weighted absolute Doppler with Doppler normalization (PWDDNabs) features extracted from radar data in accordance with an embodiment of this disclosure;

FIG. 17A and FIG. 17B illustrate histograms of different extracted features with different lookback windows, in accordance with an embodiment of this disclosure;

FIG. 18 illustrates a valid activity identification algorithm (“Algorithm 2”) implemented as part of the valid activity checker of FIG. 13 in accordance with an embodiment of this disclosure;

FIG. 19 illustrates an end-detection method with a stop confirmation in accordance with an embodiment of this disclosure;

FIG. 20 illustrates extracted features including TVD and TAD for the same period of time during which a user performed a single pinch gesture that includes a pause duration according to embodiments of this disclosure;

FIG. 21 illustrates a simplified early stop checker algorithm (“Algorithm 3”) implemented as part of the early stop checker of the end-detection method of FIG. 19 in accordance with an embodiment of this disclosure;

FIG. 22 illustrates a gesture-based early stop checker algorithm (“Algorithm 4”) implemented as part of the early stop checker of the end-detection method 1900 of FIG. 19 in accordance with an embodiment of this disclosure;

FIG. 23 illustrates a stop confirmation algorithm (“Algorithm 5”) implemented as part of the stop confirmation of the end-detection method 1900 of FIG. 19 in accordance with an embodiment of this disclosure;

FIGS. 24A and 24B illustrate two TVDs that together represent a set of gestures that have one or more pauses in the middle of the gesture, in accordance with an embodiment of this disclosure;

FIG. 25 illustrates an end-detection method for gestures requiring extra monitoring (G2M) in accordance with an embodiment of this disclosure;

FIG. 26 illustrates an end-detection method for gestures requiring shortened monitoring (G2S) in accordance with an embodiment of this disclosure;

FIG. 27 illustrates a table of performance of the system with the latency reduction features according to embodiments of this disclosure, compared to performance of a gesture recognition system without the latency reduction features of this disclosure;

FIGS. 28-32 demonstrate results of experiments of this disclosure; and

FIG. 33 illustrates a method for latency reduction in gesture recognition using mmWave radar in accordance with an embodiment of this disclosure.

### DETAILED DESCRIPTION

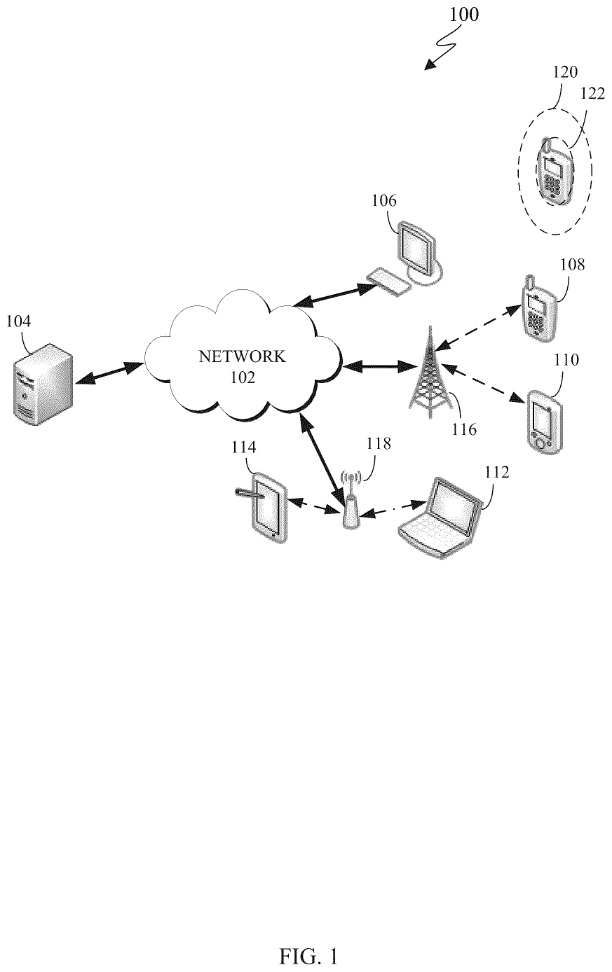

FIGS. 1 through 33, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably-arranged electronic device or wireless communication device.

Gesture-based human-computer interaction (HCI) opens a new era for smart devices (for example, smart televisions, smart tablets, smart phones, smart watches, smart home devices, AR/VR glasses, etc.). Each different sensor modality (such as, ultrasonic, IMU, optic and etc.) for gestural interaction has advantages and disadvantages. Optical sensors-based solutions for gesture-based HCI gives a favorable performance, however, are sensitive to lighting conditions and also have privacy concerns and power consumption constrains. LIDAR can resolve some of the issues, such as lighting sensitivity, privacy concerns, but the high cost of LIDAR limits its affordability to many devices.

With superior spatial and Doppler resolution of millimeter wave (mmWave) radars, radar-based gestural interaction can be a better option for gesture-based HCI without privacy concerns, affordability issues, power consumption constraints, and lighting limitations. Additionally, embodiments of this disclosure prove the good performance of mmWave radar-based gesture-based HCI.

A fully functional end-to-end gesture recognition system includes multiple components, including: (1) a gesture mode triggering mechanism for turning ON the gesture recognition system (i.e., triggering the gesture mode); (2) a radar signal feature extractor that processes raw radar measurements into a certain format to assist subsequent processing; (3) an activity detection module (ADM) for detecting when a desired gesture was performed; and (4) a gesture classifier (GC) that classifies which gesture was performed from among a predefined set of gestures in a gesture vocabulary. Due to the superb Doppler (speed) measurement capability of mmWave radar, the radar can capture and distinguish between subtle movements, and as such, dynamic gestures are suitable for a radar-based gesture recognition system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIG. 1 illustrates an example communication system in accordance with an embodiment of this disclosure. The embodiment of the communication system 100 shown in FIG. 1 is for illustration only. Other embodiments of the communication system 100 can be used without departing from the scope of this disclosure.

The communication system 100 includes a network 102 that facilitates communication between various components in the communication system 100. For example, the network 102 can communicate IP packets, frame relay frames, Asynchronous Transfer Mode (ATM) cells, or other information between network addresses. The network 102 includes one or more local area networks (LANs), metropolitan area networks (MANs), wide area networks (WANs), all or a portion of a global network such as the Internet, or any other communication system or systems at one or more locations.

In this example, the network 102 facilitates communications between a server 104 and various client devices 106-114. The client devices 106-114 may be, for example, a smartphone, a tablet computer, a laptop, a personal computer, a wearable device, a head mounted display, or the like. The server 104 can represent one or more servers. Each server 104 includes any suitable computing or processing device that can provide computing services for one or more client devices, such as the client devices 106-114. Each server 104 could, for example, include one or more processing devices, one or more memories storing instructions and data, and one or more network interfaces facilitating communication over the network 102.

Each of the client devices 106-114 represent any suitable computing or processing device that interacts with at least one server (such as the server 104) or other computing device(s) over the network 102. The client devices 106-114 include a desktop computer 106, a mobile telephone or mobile device 108 (such as a smartphone), a PDA 110, a laptop computer 112, and a tablet computer 114. However, any other or additional client devices could be used in the communication system 100. Smartphones represent a class of mobile devices 108 that are handheld devices with mobile operating systems and integrated mobile broadband cellular network connections for voice, short message service (SMS), and Internet data communications. In certain embodiments, any of the client devices 106-114 can emit and collect radar signals via a radar transceiver. In certain embodiments, the client devices 106-114 are able to sense the presence of an object located close to the client device and determine whether the location of the detected object is within a first area 120 or a second area 122 closer to the client device than a remainder of the first area 120 that is external to the first area 120. In certain embodiments, the boundary of the second area 122 is at a predefined proximity (e.g., 20 centimeters away) that is closer to the client device than the boundary of the first area 120, and the first area 120 can be a within a predefined range (e.g., 1 meter away, 2 meters away, or 5 meters away) from the client device where the user is likely to perform a gesture.

In this example, some client devices 108 and 110-114 communicate indirectly with the network 102. For example, the mobile device 108 and PDA 110 communicate via one or more base stations 116, such as cellular base stations or eNodeBs (eNBs) or gNodeBs (gNBs). Also, the laptop computer 112 and the tablet computer 114 communicate via one or more wireless access points 118, such as IEEE 802.11 wireless access points. Note that these are for illustration only and that each of the client devices 106-114 could communicate directly with the network 102 or indirectly with the network 102 via any suitable intermediate device(s) or network(s). In certain embodiments, any of the client devices 106-114 transmit information securely and efficiently to another device, such as, for example, the server 104.

Although FIG. 1 illustrates one example of a communication system 100, various changes can be made to FIG. 1. For example, the communication system 100 could include any number of each component in any suitable arrangement. In general, computing and communication systems come in a wide variety of configurations, and FIG. 1 does not limit the scope of this disclosure to any particular configuration. While FIG. 1 illustrates one operational environment in which various features disclosed in this patent document can be used, these features could be used in any other suitable system.

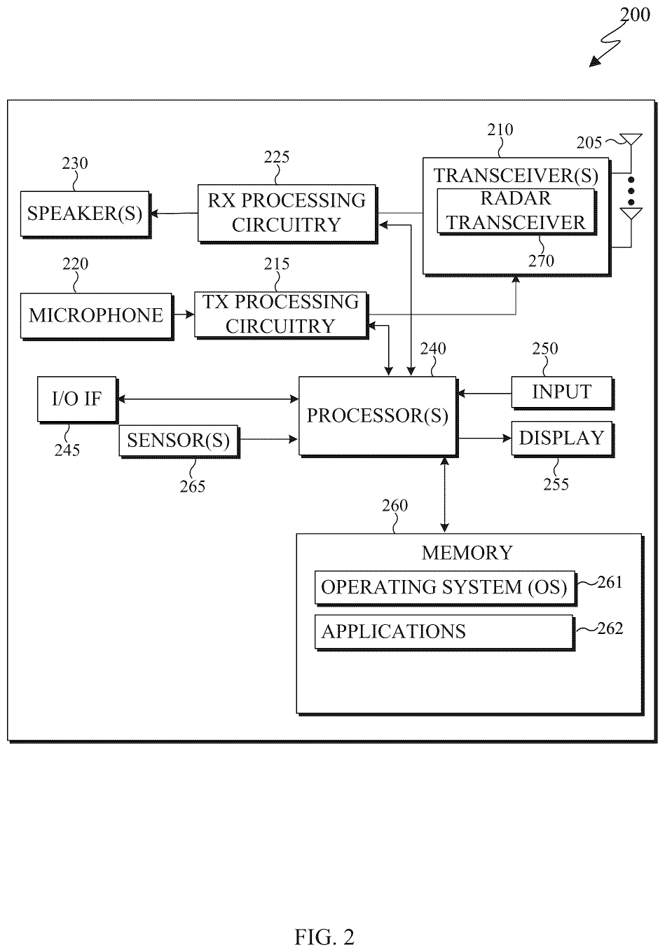

FIG. 2 illustrates an example electronic device in accordance with an embodiment of this disclosure. In particular, FIG. 2 illustrates an example electronic device 200, and the electronic device 200 could represent the server 104 or one or more of the client devices 106-114 in FIG. 1. The electronic device 200 can be a mobile communication device, such as, for example, a mobile station, a subscriber station, a wireless terminal, a desktop computer (similar to the desktop computer 106 of FIG. 1), a portable electronic device (similar to the mobile device 108, the PDA 110, the laptop computer 112, or the tablet computer 114 of FIG. 1), a robot, and the like.

As shown in FIG. 2, the electronic device 200 includes transceiver(s) 210, transmit (TX) processing circuitry 215, a microphone 220, and receive (RX) processing circuitry 225. The transceiver(s) 210 can include, for example, a RF transceiver, a BLUETOOTH transceiver, a WiFi transceiver, a ZIGBEE transceiver, an infrared transceiver, and various other wireless communication signals. The electronic device 200 also includes a speaker 230, a processor 240, an input/output (I/O) interface (IF) 245, an input 250, a display 255, a memory 260, and a sensor 265. The memory 260 includes an operating system (OS) 261, and one or more applications 262.

The transceiver(s) 210 can include an antenna array 205 including numerous antennas. The antennas of the antenna array can include a radiating element composed of a conductive material or a conductive pattern formed in or on a substrate. The transceiver(s) 210 transmit and receive a signal or power to or from the electronic device 200. The transceiver(s) 210 receives an incoming signal transmitted from an access point (such as a base station, WiFi router, or BLUETOOTH device) or other device of the network 102 (such as a WiFi, BLUETOOTH, cellular, 5G, 6G, LTE, LTE-A, WiMAX, or any other type of wireless network). The transceiver(s) 210 down-converts the incoming RF signal to generate an intermediate frequency or baseband signal. The intermediate frequency or baseband signal is sent to the RX processing circuitry 225 that generates a processed baseband signal by filtering, decoding, and/or digitizing the baseband or intermediate frequency signal. The RX processing circuitry 225 transmits the processed baseband signal to the speaker 230 (such as for voice data) or to the processor 240 for further processing (such as for web browsing data).

The TX processing circuitry 215 receives analog or digital voice data from the microphone 220 or other outgoing baseband data from the processor 240. The outgoing baseband data can include web data, e-mail, or interactive video game data. The TX processing circuitry 215 encodes, multiplexes, and/or digitizes the outgoing baseband data to generate a processed baseband or intermediate frequency signal. The transceiver(s) 210 receives the outgoing processed baseband or intermediate frequency signal from the TX processing circuitry 215 and up-converts the baseband or intermediate frequency signal to a signal that is transmitted.

The processor 240 can include one or more processors or other processing devices. The processor 240 can execute instructions that are stored in the memory 260, such as the OS 261 in order to control the overall operation of the electronic device 200. For example, the processor 240 could control the reception of downlink (DL) channel signals and the transmission of uplink (UL) channel signals by the transceiver(s) 210, the RX processing circuitry 225, and the TX processing circuitry 215 in accordance with well-known principles. The processor 240 can include any suitable number(s) and type(s) of processors or other devices in any suitable arrangement. For example, in certain embodiments, the processor 240 includes at least one microprocessor or microcontroller. Example types of processor 240 include microprocessors, microcontrollers, digital signal processors, field programmable gate arrays, application specific integrated circuits, and discrete circuitry. In certain embodiments, the processor 240 can include a neural network.

The processor 240 is also capable of executing other processes and programs resident in the memory 260, such as operations that receive and store data. The processor 240 can move data into or out of the memory 260 as required by an executing process. In certain embodiments, the processor 240 is configured to execute the one or more applications 262 based on the OS 261 or in response to signals received from external source(s) or an operator. Example, applications 262 can include a multimedia player (such as a music player or a video player), a phone calling application, a virtual personal assistant, and the like.

The processor 240 is also coupled to the I/O interface 245 that provides the electronic device 200 with the ability to connect to other devices, such as client devices 106-114. The I/O interface 245 is the communication path between these accessories and the processor 240.

The processor 240 is also coupled to the input 250 and the display 255. The operator of the electronic device 200 can use the input 250 to enter data or inputs into the electronic device 200. The input 250 can be a keyboard, touchscreen, mouse, track ball, voice input, or other device capable of acting as a user interface to allow a user in interact with the electronic device 200. For example, the input 250 can include voice recognition processing, thereby allowing a user to input a voice command. In another example, the input 250 can include a touch panel, a (digital) pen sensor, a key, or an ultrasonic input device. The touch panel can recognize, for example, a touch input in at least one scheme, such as a capacitive scheme, a pressure sensitive scheme, an infrared scheme, or an ultrasonic scheme. The input 250 can be associated with the sensor(s) 265, a camera, and the like, which provide additional inputs to the processor 240. The input 250 can also include a control circuit. In the capacitive scheme, the input 250 can recognize touch or proximity.

The display 255 can be a liquid crystal display (LCD), light-emitting diode (LED) display, organic LED (OLED), active-matrix OLED (AMOLED), or other display capable of rendering text and/or graphics, such as from websites, videos, games, images, and the like. The display 255 can be a singular display screen or multiple display screens capable of creating a stereoscopic display. In certain embodiments, the display 255 is a heads-up display (HUD).

The memory 260 is coupled to the processor 240. Part of the memory 260 could include a RAM, and another part of the memory 260 could include a Flash memory or other ROM. The memory 260 can include persistent storage (not shown) that represents any structure(s) capable of storing and facilitating retrieval of information (such as data, program code, and/or other suitable information). The memory 260 can contain one or more components or devices supporting longer-term storage of data, such as a read only memory, hard drive, Flash memory, or optical disc.

The electronic device 200 further includes one or more sensors 265 that can meter a physical quantity or detect an activation state of the electronic device 200 and convert metered or detected information into an electrical signal. For example, the sensor 265 can include one or more buttons for touch input, a camera, a gesture sensor, optical sensors, cameras, one or more inertial measurement units (IMUs), such as a gyroscope or gyro sensor, and an accelerometer. The sensor 265 can also include an air pressure sensor, a magnetic sensor or magnetometer, a grip sensor, a proximity sensor, an ambient light sensor, a bio-physical sensor, a temperature/humidity sensor, an illumination sensor, an Ultraviolet (UV) sensor, an Electromyography (EMG) sensor, an Electroencephalogram (EEG) sensor, an Electrocardiogram (ECG) sensor, an IR sensor, an ultrasound sensor, an iris sensor, a fingerprint sensor, a color sensor (such as a Red Green Blue (RGB) sensor), and the like. The sensor 265 can further include control circuits for controlling any of the sensors included therein. Any of these sensor(s) 265 may be located within the electronic device 200 or within a secondary device operably connected to the electronic device 200.

The electronic device 200 as used herein can include a transceiver that can both transmit and receive radar signals. For example, the transceiver(s) 210 includes a radar transceiver 270, as described more particularly below. In this embodiment, one or more transceivers in the transceiver(s) 210 is a radar transceiver 270 that is configured to transmit and receive signals for detecting and ranging purposes. For example, the radar transceiver 270 may be any type of transceiver including, but not limited to a WiFi transceiver, for example, an 802.11ay transceiver. The radar transceiver 270 can operate both radar and communication signals concurrently. The radar transceiver 270 includes one or more antenna arrays, or antenna pairs, that each includes a transmitter (or transmitter antenna) and a receiver (or receiver antenna). The radar transceiver 270 can transmit signals at various frequencies. For example, the radar transceiver 270 can transmit signals at frequencies including, but not limited to, 6 GHz, 7 GHz, 8 GHz, 28 GHz, 39 GHz, 60 GHz, and 77 GHz. In some embodiments, the signals transmitted by the radar transceiver 270 can include, but are not limited to, millimeter wave (mmWave) signals. The radar transceiver 270 can receive the signals, which were originally transmitted from the radar transceiver 270, after the signals have bounced or reflected off of target objects in the surrounding environment of the electronic device 200. In some embodiments, the radar transceiver 270 can be associated with the input 250 to provide additional inputs to the processor 240.

In certain embodiments, the radar transceiver 270 is a monostatic radar. A monostatic radar includes a transmitter of a radar signal and a receiver, which receives a delayed echo of the radar signal, which are positioned at the same or similar location. For example, the transmitter and the receiver can use the same antenna or nearly co-located while using separate, but adjacent antennas. Monostatic radars are assumed coherent such that the transmitter and receiver are synchronized via a common time reference. FIG. 4, below, illustrates an example monostatic radar.

In certain embodiments, the radar transceiver 270 can include a transmitter and a receiver. In the radar transceiver 270, the transmitter of can transmit millimeter wave (mmWave) signals. In the radar transceiver 270, the receiver can receive the mmWave signals originally transmitted from the transmitter after the mmWave signals have bounced or reflected off of target objects in the surrounding environment of the electronic device 200. The processor 240 can analyze the time difference between when the mmWave signals are transmitted and received to measure the distance of the target objects from the electronic device 200. Based on the time differences, the processor 240 can generate an image of the object by mapping the various distances.

Although FIG. 2 illustrates one example of electronic device 200, various changes can be made to FIG. 2. For example, various components in FIG. 2 can be combined, further subdivided, or omitted and additional components can be added according to particular needs. As a particular example, the processor 240 can be divided into multiple processors, such as one or more central processing units (CPUs), one or more graphics processing units (GPUs), one or more neural networks, and the like. Also, while FIG. 2 illustrates the electronic device 200 configured as a mobile telephone, tablet, or smartphone, the electronic device 200 can be configured to operate as other types of mobile or stationary devices.

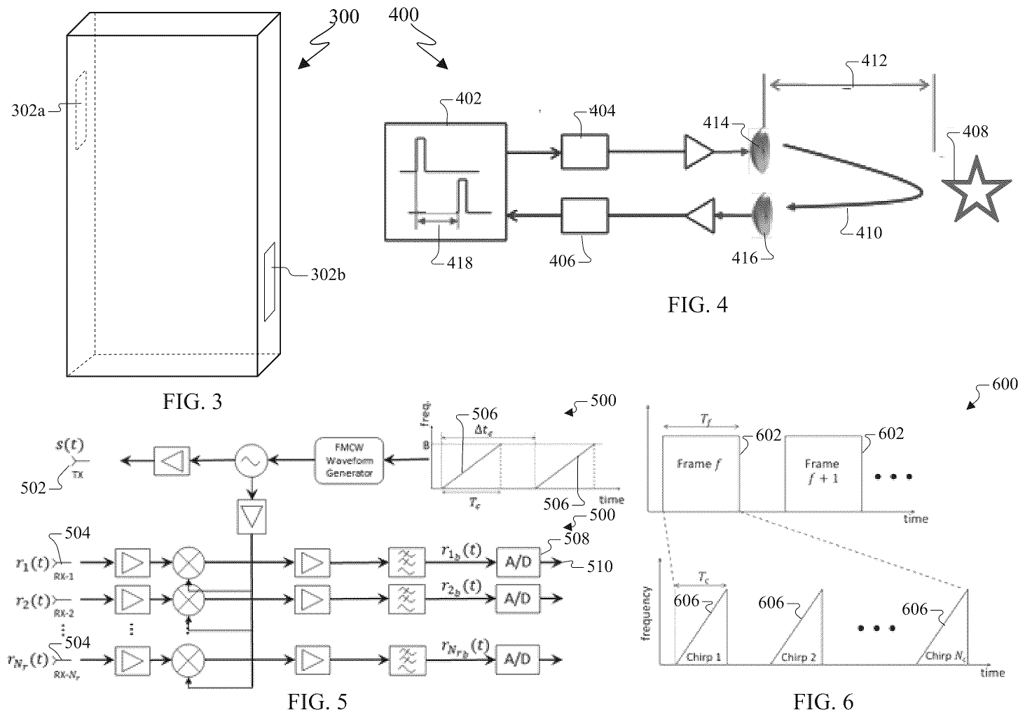

FIG. 3 illustrates a three-dimensional view of an example electronic device 300 that includes multiple millimeter wave (mmWave) antenna modules 302 in accordance with an embodiment of this disclosure. The electronic device 300 could represent one or more of the client devices 106-114 in FIG. 1 or the electronic device 200 in FIG. 2. The embodiments of the electronic device 300 illustrated in FIG. 3 are for illustration only, and other embodiments can be used without departing from the scope of the present disclosure.

As used herein, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

The first antenna module 302a and the second antenna module 302b are positioned at the left and the right edges of the electronic device 300. For simplicity, the first and second antenna modules 302a-302b are generally referred to as an antenna module 302. In certain embodiments, the antenna module 302 includes an antenna panel, circuitry that connects the antenna panel to a processor (such as the processor 240 of FIG. 2), and the processor.

The electronic device 300 can be equipped with multiple antenna elements. For example, the first and second antenna modules 302a-302b are disposed in the electronic device 300 where each antenna module 302 includes one or more antenna elements. The electronic device 300 uses the antenna module 302 to perform beamforming when the electronic device 300 attempts to establish a connection with a base station (for example, base station 116).

FIG. 4 illustrates an example architecture of a monostatic radar in an electronic device 400 in accordance with an embodiment of this disclosure. The embodiments of the architecture of the monostatic radar illustrated in FIG. 4 are for illustration only, and other embodiments can be used without departing from the scope of the present disclosure.

The electronic device 400 that includes a processor 402, a transmitter 404, and a receiver 406. The electronic device 400 can be similar to any of the client devices 106-114 of FIG. 1, the electronic device 200 of FIG. 2, or the electronic device 300 of FIG. 3. The processor 402 is similar to the processor 240 of FIG. 2. Additionally, the transmitter 404 and the receiver 406 can be included within the radar transceiver 270 of FIG. 2. The radar can be used to detect the range, velocity and/or angle of a target object 408. Operating at mmWave frequency with GHz of bandwidth (e.g., 2, 3, 5 or 7 GHz bandwidth), the radar can be useful for applications such as proximity sensing, gesture recognition, liveness detection, mmWave blockage detection, and so on.

The transmitter 404 transmits a signal 410 (for example, a monostatic radar signal) to the target object 408. The target object 408 is located a distance 412 from the electronic device 400. In certain embodiments, the target object 408 corresponds to the objects that form the physical environment around the electronic device 400. For example, the transmitter 404 transmits a signal 410 via a transmit antenna 414. The signal 410 reflects off of the target object 408 and is received by the receiver 406 as a delayed echo, via a receive antenna 416. The signal 410 represents one or many signals that can be transmitted from the transmitter 404 and reflected off of the target object 408. The processor 402 can identify the information associated with the target object 408 based on the receiver 406 receiving the multiple reflections of the signals.

The processor 402 analyzes a time difference 418 from when the signal 410 is transmitted by the transmitter 404 and received by the receiver 406. The time difference 418 is also referred to as a delay, which indicates a delay between the transmitter 404 transmitting the signal 410 and the receiver 406 receiving the signal after the signal is reflected or bounced off of the target object 408. Based on the time difference 418, the processor 402 derives the distance 412 between the electronic device 400, and the target object 408. The distance 412 can change when the target object 408 moves while electronic device 400 is stationary. The distance 412 can change when the electronic device 400 moves while the target object 408 is stationary. Also, the distance 412 can change when the electronic device 400 and the target object 408 are both moving. As described herein, the electronic device 400 that includes the architecture of a monostatic radar is also referred to as a radar 400.

The signal 410 can be a radar pulse as a realization of a desired “radar waveform,” modulated onto a radio carrier frequency. The transmitter 404 transmits the radar pulse signal 410 through a power amplifier and transmit antenna 414, either omni-directionally or focused into a particular direction. A target (such as target 408), at a distance 412 from the location of the radar (e.g., location of the transmit antenna 414) and within the field-of-view of the transmitted signal 410, will be illuminated by RF power density pₜ (in units of W/m²) for the duration of the transmission of the radar pulse. Herein, the distance 412 from the location of the radar to the location of the target 408 is simply referred to as “R” or as the “target distance.” To first order, pₜ can be described by Equation 1, where P_{T} represents transmit power in units of watts (W), G_{T} represents transmit antenna gain in units of decibels relative to isotropic (dBi), A_{T} represents effective aperture area in units of square meters (m²), and λ represents wavelength of the radar signal RF carrier signal in units of meters. In Equation 1, effects of atmospheric attenuation, multi-path propagation, antenna losses, etc. have been neglected.

$${p}_{t} = \frac{{P}_{T}}{4 π {R}^{2}} {G}_{T} = \frac{{P}_{T}}{4 π {R}^{2}} \frac{{A}_{T}}{( {λ}^{2} / 4 π )} = {P}_{T} \frac{{A}_{T}}{{λ}^{2} {R}^{2}} \qquad ( 1 )$$

The transmit power density impinging onto the surface of the target will reflect into the form of reflections depending on the material composition, surface shape, and dielectric behavior at the frequency of the radar signal. Note that off-direction scattered signals are typically too weak to be received back at the radar receiver (such as receive antenna 416 of FIG. 4), so typically, only direct reflections will contribute to a detectable receive signal. In essence, the illuminated area(s) of the target with normal vectors pointing back at the receiver will act as transmit antenna apertures with directivities (gains) in accordance with corresponding effective aperture area(s). The power of the reflections, such as direct reflections reflected and received back at the radar receiver, can be described by Equation 2, where P_{refl} represents effective (isotropic) target-reflected power in units of watts, Aₜ represents effective target area normal to the radar direction in units of m², Gₜ represents corresponding aperture gain in units of dBi, and RCS represents radar cross section in units of square meters. Also in Equation 2, rₜ represents reflectivity of the material and shape, is unitless, and has a value between zero and one inclusively ([0, . . . , 1]). The RCS is an equivalent area that scales proportional to the actual reflecting area-squared, inversely proportional with the wavelength-squared, and is reduced by various shape factors and the reflectivity of the material itself. For a flat, fully reflecting mirror of area Aₜ, large compared with λ², RCS=4π_{At}²/λ². Due to the material and shape dependency, it is generally not possible to deduce the actual physical area of a target from the reflected power, even if the target distance R is known. Hence, the existence of stealth objects that choose material absorption and shape characteristics carefully for minimum RCS.

$${P}_{refl} = {p}_{t} {A}_{t} {G}_{t} ∼ {p}_{t} {A}_{t} {r}_{t} \frac{{A}_{t}}{( {λ}^{2} / 4 π )} = {p}_{t} RCS \qquad ( 2 )$$

The target-reflected power (P_{R}) at the location of the receiver results from the reflected-power density at the reverse distance R, collected over the receiver antenna aperture area. For example, the target-reflected power (P_{R}) at the location of the receiver can be described by Equation 3, where A_{R} represents the receiver antenna effective aperture area in units of square meters. In certain embodiments, A_{R} may be the same as A_{T}.

$${P}_{R} = \frac{{P}_{refl}}{4 π {R}^{2}} {A}_{R} = {P}_{T} \cdot RCS \frac{{A}_{T} {A}_{R}}{4 {πλ}^{2} {R}^{4}} \qquad ( 3 )$$

The target distance R sensed by the radar 400 is usable (for example, reliably accurate) as long as the receiver signal exhibits sufficient signal-to-noise ratio (SNR), the particular value of which depends on the waveform and detection method used by the radar 500 to sense the target distance. The SNR can be expressed by Equation 4, where k represents Boltzmann's constant, T represents temperature, and kT is in units of W/Hz]. In Equation 4, B represents bandwidth of the radar signal in units of Hertz (Hz), F represents receiver noise factor. The receiver noise factor represents degradation of receive signal SNR due to noise contributions of the receiver circuit itself

$$SNR = \frac{{P}_{R}}{kT \cdot B \cdot F} \qquad ( 4 )$$

If the radar signal is a short pulse of duration T_{P} (also referred to as pulse width), the delay τ between the transmission and reception of the corresponding echo can be expressed according to Equation 5, where c is the speed of (light) propagation in the medium (air).

τ=2R/c (5)

In a scenario in which several targets are located at slightly different distances from the radar 400, the individual echoes can be distinguished as such if the delays differ by at least one pulse width. Hence, the range resolution (ΔR) of the radar 400 can be expressed according to Equation 6.

ΔR=cΔτ/2=cT_{P}/2 (6)

If the radar signal is a rectangular pulse of duration T_{P}, the rectangular pulse exhibits a power spectral density P(f) expressed according to Equation 7. The rectangular pulse has a first null at its bandwidth B, which can be expressed according to Equation 8. The range resolution ΔR of the radar 400 is fundamentally connected with the bandwidth of the radar waveform, as expressed in Equation 9.

P(f)˜(sin(πfT_{P})/(πfT_{P}))² (7)

B=1/T_{P} (8)

ΔR=c/2B (9)

Although FIG. 4 illustrates one example radar 400, various changes can be made to FIG. 4. For example, the radar 400 could include hardware implementing a monostatic radar with 5G communication radio, and the radar can utilize a 5G waveform according to particular needs. In another example, the radar 400 could include hardware implementing a standalone radar, in which case, the radar transmits its own waveform (such as a chirp) on non-5G frequency bands such as the 24 GHz industrial, scientific and medical (ISM) band. In another particular example, the radar 400 could include hardware of a 5G communication radio that is configured to detect nearby objects, namely, the 5G communication radios has a radar detection capability.

FIG. 5 illustrates a mmWave monostatic frequency-modulated continuous wave (FMCW) transceiver system 500 in accordance with an embodiment of this disclosure. The FMCW transceiver system 500 could be included in one or more of the client devices 106-114 of FIG. 1, the electronic device 200 of FIG. 2, or the electronic device 300 of FIG. 3. The transmitter and the receiver within the FMCW transceiver system 500 can be included within the radar transceiver 270 of FIG. 2. The FMCW transceiver system 500 operates as a radar that can be used to detect the range, velocity and/or angle of a target object (such as the target object 408 of FIG. 4). The embodiments of the FMCW transceiver system 500 illustrated in FIG. 5 are for illustration only, and other embodiments can be used without departing from the scope of the present disclosure.

The FMCW transceiver system 500 includes a mmWave monostatic FMCW radar with sawtooth linear frequency modulation. The operational bandwidth of the radar can be described according to Equation 10, where fₘᵢₙ and fₘₐₓ are minimum and maximum sweep frequencies of the radar, respectively. The radar is equipped with a single transmit antenna 502 and Nᵣ receive antennas 504.

B=fₘᵢₙ−fₘₐₓ (10)

The receive antennas 504 form a uniform linear array (ULA) with spacing d₀, which is expressed according to Equation 11, where λₘₐₓ represents a maximum wavelength that is expressed according to Equation 12, c is the velocity of the light.

$${d}_{0} = \frac{{λ}_{max}}{2} \qquad ( 11 )$$

$${λ}_{max} = \frac{c}{{f}_{min}} \qquad ( 12 )$$

The transmitter transmits a frequency modulated sinusoid chirp 506 of duration T_{c} over the bandwidth B. Hence, the range resolution rₘᵢₙ of the radar is expressed according to Equation 13. In the time domain, the transmitted chirp s(t) 506 is expressed according to Equation 14, where A_{T} represents the amplitude of the transmit signal and S represents a ratio that controls the frequency ramp of s(t). The ratio S is expressed according to Equation 15.

$${r}_{min} = \frac{c}{2 B} \qquad ( 13 )$$

$$s ( t ) = {A}_{T} cos ( 2 π ( {f}_{min} t + \frac{1}{2} {St}^{2} ) ) \qquad ( 14 )$$

$$S = \frac{B}{{T}_{c}} \qquad ( 15 )$$

When the transmitted chirp s(t) 506 impinges on an object (such as a finger, hand, or other body part of a human), the reflected signal from the object is received at the Nᵣ receive antennas 504. The object is at located at a distance R₀ from the radar (for example, from the transmit antenna 502). In this disclosure, the distance R₀ is also referred to as the “object range,” “object distance,” or “target distance.” Assuming one dominant reflected path, the received signal at the reference antenna can be expressed according to Equation 16, where A_{R} represents the amplitude of the reflected signal which is a function of A_{T}, distance between the radar and the reflecting object, and the physical properties of the object. Also in Equation 16, T represents the round trip time delay to the reference antenna, and can be express according to Equation 17.

$$r ( t ) = {A}_{R} cos ( 2 π ( {f}_{min} ( t - τ ) + \frac{1}{2} {S ( t - τ )}^{2} ) ) \qquad ( 16 )$$

$$τ = \frac{2 {R}_{0}}{c} \qquad ( 17 )$$

The beat signal r_{b(t)} for the reference antenna is obtained by low pass filtering the output of the mixer. For the reference antenna, the beat signal is expressed according to Equation 18, where the last approximation follows from the fact that the propagation delay is orders of magnitude less than the chirp duration, namely, τ«T_{c}.

$${r}_{b ( t )} = \frac{{A}_{T} {A}_{R}}{2} cos ( 2 π ( {f}_{min} τ + S τ t - \frac{1}{2} S {τ}^{2} ) ) \approx \frac{{A}_{T} {A}_{R}}{2} cos ( 2 π S τ t - 2 π {f}_{min} τ ) \qquad ( 18 )$$

Two of the parameters that the beat signal has will be described in further in this disclosure, namely the beat frequency f_{b} and the beat phase ϕ_{b}. The beat frequency is used to estimate the object range R₀. The beat frequency can be expressed according to Equation 19. The beat phase can be expressed according to Equation 20.

$${f}_{b} = S τ = \frac{S 2 {R}_{0}}{c} \qquad ( 19 )$$

$${ϕ}_{b} = 2 π {f}_{min} τ \qquad ( 20 )$$

Further, for a moving target object, the velocity can be estimated using beat phases corresponding to at least two consecutive chirps. For example, if two chirps 506 are transmitted with a time separation of Δt_{c} (where Δt_{c}>T_{c}), then the difference in beat phases is expressed according to Equation 21, where v₀ is the velocity of the object.

$${Δϕ}_{b} = \frac{4 πΔ R}{{λ}_{max}} = \frac{4 π {v}_{0} Δ {t}_{c}}{{λ}_{max}} \qquad ( 21 )$$

The beat frequency is obtained by taking the Fourier transform of the beat signal that directly gives the range R₀. To do so, the beat signal r_{b}(t) is passed through an analog to digital converter (ADC) 508 with a sampling frequency Fₛ. The sample frequency can be expressed according to Equation 22, where Tₛ represents the sampling period. As a consequence, each chirp 506 is sampled Nₛ times where the chirp duration Tc is expressed according to Equation 23.

$${F}_{s} = \frac{1}{{T}_{s}} \qquad ( 22 )$$

$${T}_{c} = {N}_{s} {T}_{s} \qquad ( 23 )$$

The ADC output 510 corresponding to the n-th chirp is xₙ∈ [symbol] and defined according to Equation 24. The Nₛ-point fast Fourier transform (FFT) output of xₙ is denoted as [symbol] ₙ. Assuming a single object, the frequency bin that corresponds to the beat frequency can be obtained according to Equation 25. In consideration of the fact that the radar resolution rₘᵢₙ is expressed as the speed of light c divided by double the chirp bandwidth B (shown above in Equation 13), the n-th bin of the FFT output corresponds to a target located within

$$[ \frac{kc}{2 B} - \frac{kc}{4 B} , \frac{kc}{2 B} + \frac{kc}{4 B} ] for 1 \leq k \leq {N}_{s} - 1.$$

As the range information of the object is embedded in [symbol] ₙ, it is also referred to as the range FFT.

xₙ=[{x[k,n]}ₖ₌₀^{N}^{ₛ}⁻¹] where x[k,n]=r_{b}(nΔt_{c}+kTs) (24)

k*=arg max∥ [symbol] ₙ∥² (25)

FIG. 6 illustrates a frame-based radar transmission timing structure 600 in accordance with an embodiment of this disclosure. The embodiments of the frame-based radar transmission timing structure 600 illustrated in FIG. 6 are for illustration only, and other embodiments can be used without departing from the scope of the present disclosure.

The radar transmission timing structure 600 is used to facilitate velocity estimation. The radar transmissions are divided into frames 602, where each frame consists of N_{c} equally spaced chirps 606. The chirps 606 of FIG. 6 can be similar to the chirps 506 of FIG. 5. The range FFT of each chirp 606 provides the phase information on each range bin. For a given range bin, the Doppler spectrum, which includes the velocity information, is obtained by applying N_{c}-point FFT across the range FFTs of chirps corresponding to that range bin. The range-Doppler map (RDM) is constructed by repeating the above-described procedure for each range bin. The RDM is denoted as M, which is obtained by taking N_{c}-point FFT across all the columns of R. In Equation 26, this disclosure provides the following mathematical definition:

R∈ [symbol] as R=[X₀,X₁, . . . ,X_{N}_{_{c}}₋₁] (26)

The minimum velocity that can be estimated corresponds to the Doppler resolution, which is inversely proportional to the number of chirps N_{c} and is expressed accorded to Equation 27.

$${v}_{min} = \frac{{λ}_{max}}{2 {N}_{c} {T}_{c}} \qquad ( 27 )$$

Further, the maximum velocity that can be estimated as shown in Equation 28.

$${v}_{max} = \frac{{N}_{c}}{2} {v}_{min} = \frac{{λ}_{max}}{4 {T}_{c}} \qquad ( 28 )$$

As an example, the FMCW transceiver system 500 of FIG. 5 can generate and utilize the frame-based radar transmission timing structure 600 of FIG. 6 for further processing, such as radar signal processing that includes clutter removal. The description of a clutter removal procedure will refer to both FIGS. 5 and 6.

In the case of a monostatic radar, the RDM obtained using the above-described technique has significant power contributions from direct leakage from the transmitting antenna 502 to the receiving antennas 504. Further, the contributions (e.g., power contributions) from larger and slowly moving body parts, such as the fist and forearm can be higher compared to the power contributions from the fingers. Because the transmit and receive antennas 502 and 504 are static, the direct leakage appears in the zero-Doppler bin in the RDM. On the other hand, the larger body parts (such as the fist and forearm) move relatively slowly compared to the fingers. Hence, signal contributions from the larger body parts mainly concentrate at lower velocities. Because the contributions from both these artifacts dominate the desired signal in the RDM, the clutter removal procedure according to embodiments of this disclosure remove them using appropriate signal processing techniques. The static contribution from the direct leakage is simply removed by nulling the zero-Doppler bin. To remove the contributions from slowly moving body parts, the sampled beat signal of all the chirps in a frame are passed through a first-order infinite impulse response (IIR) filter. For the reference frame f 602, the clutter removed samples corresponding to all the chirps can be obtained as expressed in Equation 29, where y̅_̅{̅f̅}̅[k, n] includes contributions from all previous samples of different chirps in the frame.

[symbol]

[k,n]=x_{f}[k,n]−y̅_̅{̅f̅}̅[k,n−1]

y̅_̅{̅f̅}̅[k,n]=αx_{f}[k,n]+(1−α)y̅_̅{̅f̅}̅[k,n−1]

for 0≤k≤Nₛ−1 and 0≤n≤N_{c}−1 (29)

This disclosure uses the following notation as shown in Table 1. The fast Fourier transform (FFT) output of a vector x is denoted as [symbol] . The N×N identity matrix is represented by I_{N}, and the N×1 zero vector is 0_{N×1}. The set of complex and real numbers are denoted by [symbol] and [symbol] , respectively.

TABLE 1
Notation

| Letter or Symbol | Typeface | What is represented |
|---|---|---|
| x | bold lowercase | column vectors |
| X | bold uppercase | matrices |
| x and X | non-bold letters | Scaler |
| T | superscript | transpose |
| * | superscript | conjugate transpose |

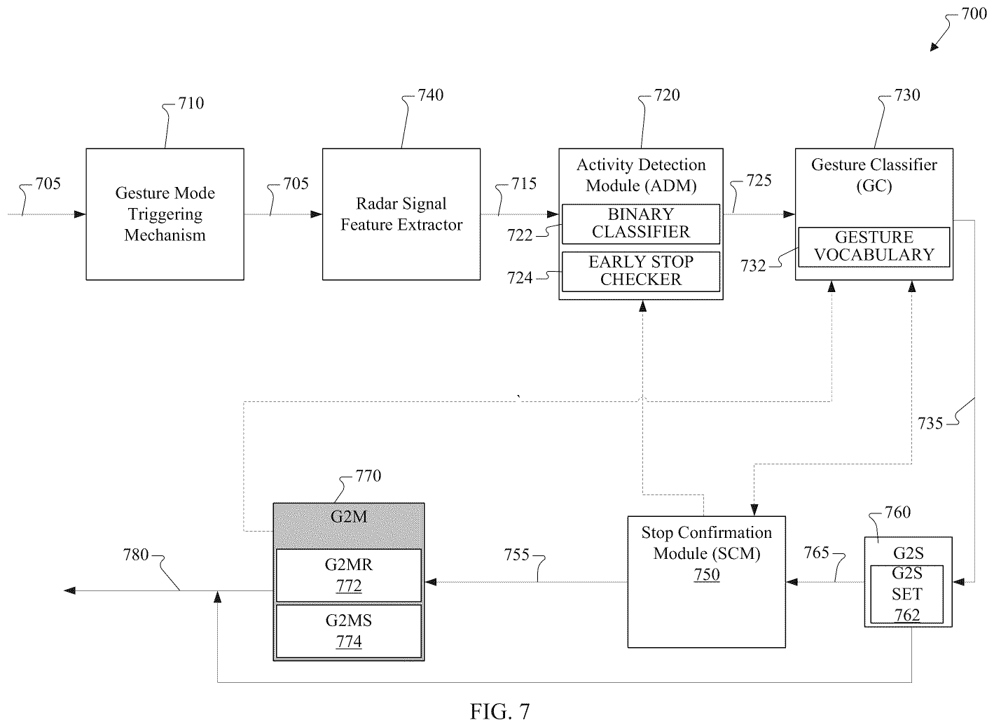

FIG. 7 illustrates a radar-based end-to-end gesture recognition system 700 in accordance with an embodiment of this disclosure. The embodiment of the system 700 shown in FIG. 7A is for illustration only, and other embodiments can be used without departing from the scope of this disclosure.

The end-to-end gesture recognition system 700 can be used to recognize a dynamic micro-gesture. The end-to-end gesture recognition system 700 has a gesture detection mode, which is activated by a trigger, and which can be in an ON state or an OFF state. The processing pipeline within the end-to-end gesture recognition system 700 includes a gesture mode triggering mechanism 710, an activity detection module (ADM) 720 that includes a binary classifier 722, and a gesture classifier (GC) 730 that includes a gesture vocabulary 800. The system 700 includes a radar signal feature extractor 740, which is an additional component of the processing pipeline in certain embodiments, or which can be a sub-component of the ADM 720 in other embodiments. For simplicity, the radar signal feature extractor 740 is also referred to as feature extractor 740.

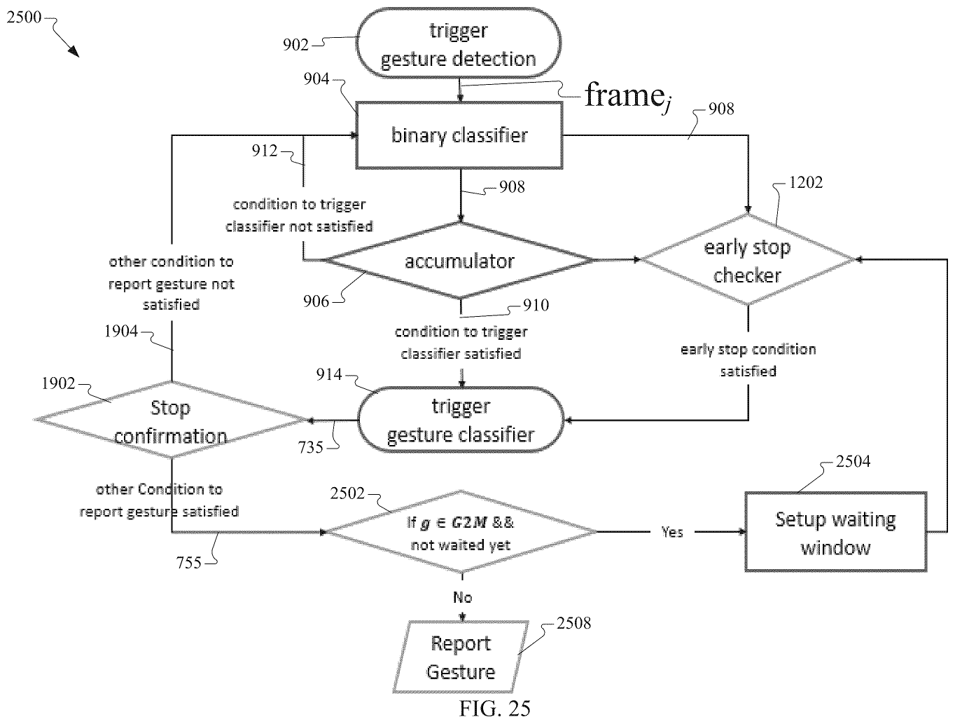

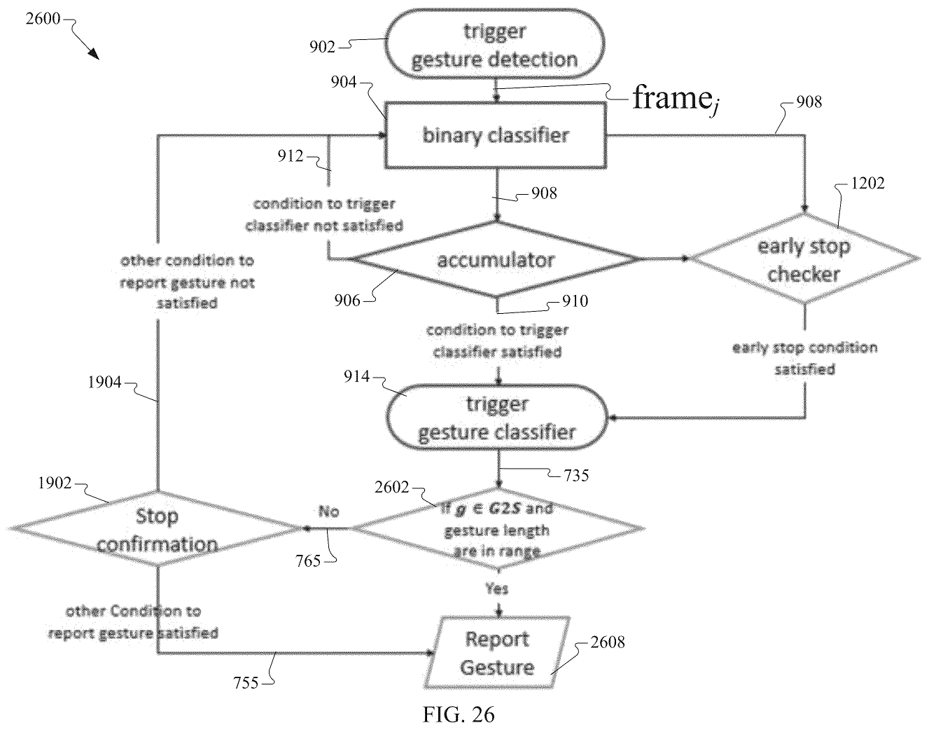

This disclosure provides various embodiments of latency reduction within the end-to-end gesture recognition system 700. In a first embodiment of the system 700, the ADM 720 includes an adaptive early stop checker 724 to reduce the latency. In a second embodiment, the system 700 further includes a stop confirmation module (SCM) 750 to further reduce the latency, which is an upgrade compared to the first embodiment of the system 700 without the SCM 750. In a third embodiment, the SCM 750 includes one or more gesture-based latency reduction modules, namely, a G2S module 760 and/or a G2M module 770. The gesture-based latency reduction modules 760 and 770 apply different stop confirmation conditions to different sets of gestures, namely, G2S set 762, G2MR set 772, and G2MS set 774. Details of the G2M module 770 are described further below with FIG. 25. Details of the G2S module 760 are described further below with FIG. 26.

The gesture mode triggering mechanism 710 triggers the gesture detection mode, controlling whether the gesture detection mode of the system 700 is in the ON or OFF state. When the gesture detection mode of the system 700 is in the ON state, the gesture mode triggering mechanism 710 enables the processing pipeline of the system 700 to receive the incoming raw radar data 705. The ON/OFF state of the gesture detection mode, which is controlled by the gesture mode triggering mechanism 710, can control the input of the feature extractor 740 to enable/disable receiving the incoming raw radar data 705 from the radar transceiver. For example, gesture mode triggering mechanism 710 can include a switch that connects/disconnects the feature extractor 740 to an input for the incoming raw radar data 705.

The gesture mode triggering mechanism 710 can apply multiple methods of triggering, for example by applying application-based triggering or proximity-based triggering. Applying application-based triggering, the gesture mode triggering mechanism 710 puts or maintains the gesture detection mode in the OFF state in response to a determination that a first application, which does not utilize dynamic gestures, is active (e.g., currently executed by the electronic device; or a user of the electronic device is interacting with a first application). On the other hand, the gesture mode triggering mechanism 710 turns ON the gesture detection mode in response to a determination that a second application, which utilizes or processes dynamic gestures, is being executed by the electronic device or a determination that the user is interacting with the second application. The second application can represent one or more of only a few applications with which the dynamic finger/micro-gesture gestures may be used, and as such, the gesture detection mode is triggered infrequently, when the user is actively using the second application exploiting gestural interaction. As an example, the first application can be an email application or a text message application, and the second application can be a multimedia player application. A user of the multimedia player application may want to fast forward or rewind by swiping right or swiping left in-air, in which case, the multimedia player application uses the system 700 and is able process such in-air dynamic micro-gestures. As such, the second application is also referred to as a “gestural application.”

In the case of applying proximity-based triggering, the gesture detection mode is activated when an object in close proximity to the radar is detected. The gesture mode triggering mechanism 710 puts or maintains the gesture detection mode in the OFF state if the user (i.e., target object) is located outside of the first area 120 (FIG. 1) or far from the electronic device, but puts the gesture detection mode in the ON state in response to a determination that the user is located inside the first area 120. In certain embodiments, to save power and avoid using the gesture mode when the user is likely performing a touchscreen gesture as opposed to an in-air gesture, the gesture mode triggering mechanism 710 puts the gesture detection mode in the ON state in response to a determination that the user is located outside the second area 122 and still inside the first area 120, but turns OFF the gesture detection mode when the user is located inside the second area 122. A benefit of activating the gesture detection mode based on proximity detection comes in reduced power consumption. It is only when an object is detected in radar's proximity, that the gesture mode triggering mechanism 710 switches ON the gesture detection mode. A simpler task of proximity detection (relative to the complex task of gesture detection) can be achieved reliably with radar configurations that have low power consumption. The proximity detection function can itself be based on the radar data that is also used for gesture detection. After an object is detected in close proximity to the radar, then the system 700 is switched into the gesture detection mode, which could be based on another radar configuration that consumes more power. The embodiments of this disclosure relate to gesture detection, and this disclosure does not delve deeply into the implementation of the triggering mechanism 710.

In the processing pipeline of the system 700, once the gesture mode is triggered, the incoming raw radar data 705 is first processed by the radar signal feature extractor 740 (including a signal processing module) to extract features 715 including Time-velocity data (TVD) and/or Time-angle data (TAD). The TVD and TAD can be presented or displayed as time-velocity diagram and time-angle diagram, respectively. The extracted features 715 are referred to as radar data, but distinct from the raw radar data 705.

The ADM 720 obtains the extracted features 715 from the feature extractor 740. The purpose of the ADM 720 is to determine the end of a gesture and subsequently trigger the GC 730 to operate. Particularly, the ADM 720 detects the end of a gesture, determines the portion of radar data containing the gesture (“gesture data”) 725, and that gesture data 725 is fed to the GC 730 to predict the gesture type. While the gesture recognition mode is activated, the ADM 720 obtains radar data (e.g., receives raw radar data 705 from the radar transceiver 270 of FIG. 2 or receives extracted features 715 from the feature extractor 740), determines whether the obtained radar data 715 includes gesture activity, and further determines an end of a gesture (e.g., end of gesture activity). To determine whether the obtained radar data 715 includes an end of a gesture, the ADM 720 executes the binary classifier 722 function of generating a prediction that is an indicator of “class 1” if the radar data 715 includes an end of a gesture or an indicator of “class 0” if the radar data 715 does not include an end of a gesture.

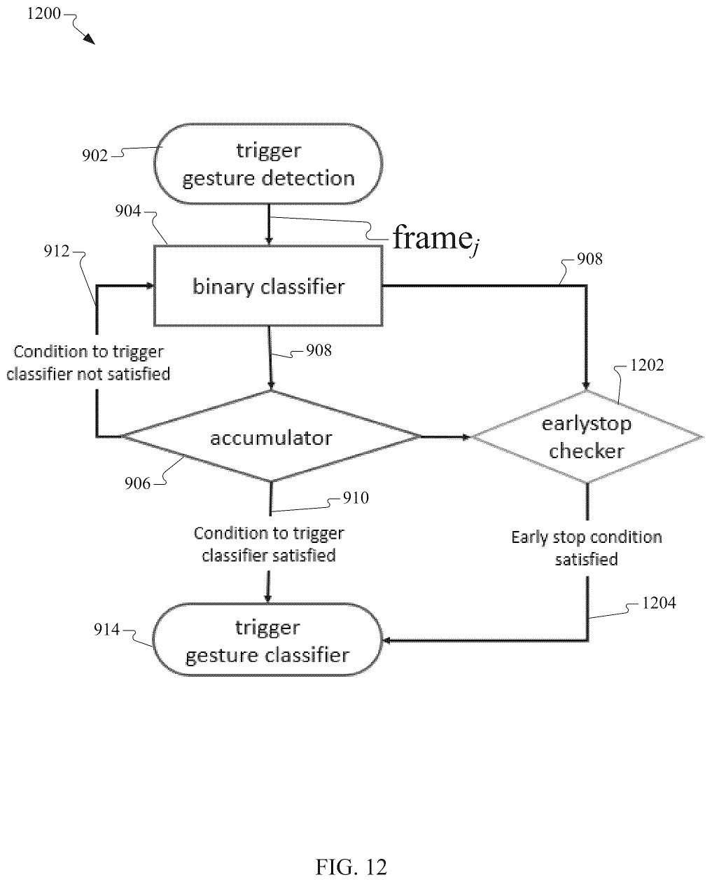

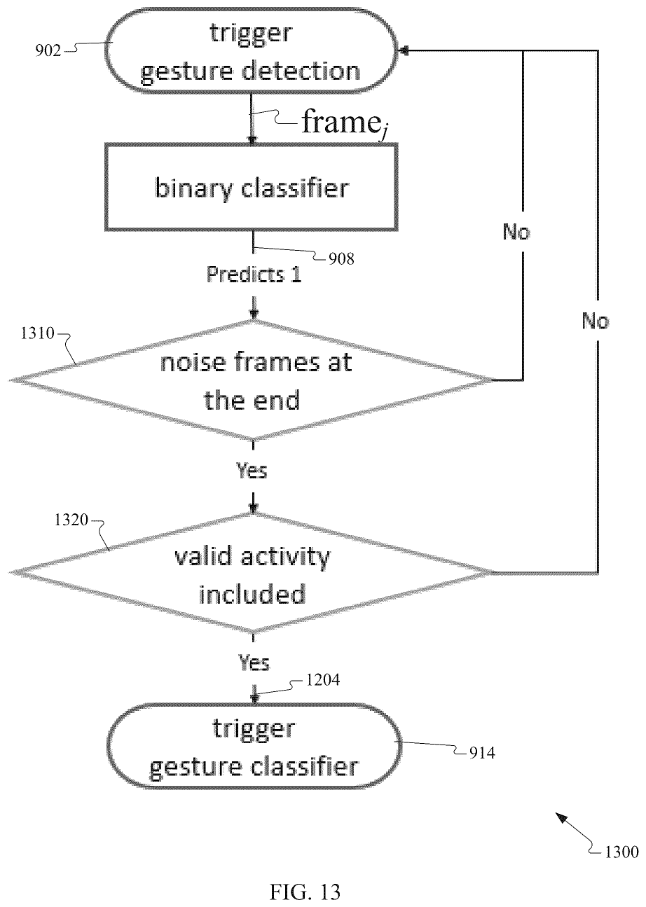

Also, the ADM 720 executes the early stop checker 724 to determine an end of a gesture based on predictions obtained from the binary classifier 722. The early stop checker 724 is described further below at FIGS. 12 and 13, wherein early stop checker 724 provides an adaptive latency reduction scheme that allows early termination of an accumulator if an early stop condition is satisfied.

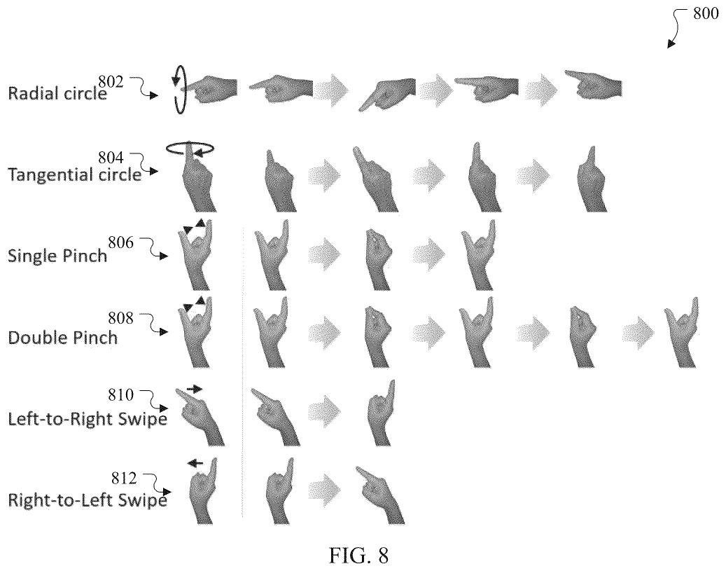

The GC 730 is triggered when the end of a gesture is detected by the ADM 720. The GC 730 receives the gesture data 725 and determines which specific gesture, out of a set of pre-determined gestures that are collectively referred to as “gesture vocabulary” 800, is performed. That is, GC 730 identifies or recognizes the gesture performed by the user based on the TVD and/or TAD within the gesture data 725 received. As an example only, the gesture vocabulary 800 of this disclosure is a set of predetermined gestures that includes three pairs of dynamic micro-gestures, namely, total six gestures, as shown in FIG. 8. The output 735 from the GC 730 includes a predicted gesture type, a prediction confidence value of the GC, a derived gesture length, and so forth.

Further, the system 700 outputs an event indicator 780 indicating that a user of the electronic device performed the gesture classified by the GC 730. In the first embodiment of the system 700, the event indicator 780 is output by the GC 730, and accordingly, the output 735 is the event indicator 780. In the second embodiment of the system 700, the SCM 750 determines whether the output 735 from the GC 730 satisfies a gesture reporting condition, outputs an indicator 755 in response to a determination that the gesture reporting condition is satisfied, but in response to a determination that the gesture reporting condition is not satisfied, defers outputting an event indicator 780 and controls the ADM and the GC 730. In this disclosure, outputting the event indicator 780 is also referred to as reporting a gesture to applications (such as applications 262 of FIG. 2). For example, when gesture reporting condition is satisfied, the indicator 755 (including the output 735 from the GC 730, which is obtained by the SCM 750) is output from the system 700 as the event indicator 780 reported to the second application. In the third embodiment of the system 700, the G2S module 760 determines whether the output 735 from the GC 730 satisfies a condition to bypass the SCM 750, outputs an indicator 765 to trigger the SCM 750 in response to a determination the condition to bypass the SCM 750 is not satisfied, but in response to a determination to bypass the SCM 750, enables the output 735 from the GC 730 to be reported as the event indicator 780 to the second application.

Although FIG. 7 illustrates one example radar-based end-to-end gesture recognition system 700, various changes can be made to FIG. 7. For example, various components in FIG. 7 can be combined, further subdivided, or omitted and additional components can be added according to particular needs. As another example, the system 700 is described for a gesture recognition use case, however, embodiments of this disclosure can be used for other uses cases other than gesture recognition, including but not limited to: sensing based maximum permissible exposure (MPE) management; proximity sensing; gesture recognition; liveness detection; sleep monitoring; and vital sign monitoring (breathing/heart rate detection). The system 700 is described with respect to mmWave radar, however, embodiments of this disclosure can be used with other types of radar modalities, other than mmWave radar. Commercialization of mmWave radar sensing on consumer devices is an emerging industry trend.

FIG. 8 illustrates a gesture set that forms a gesture vocabulary 800 in accordance with an embodiment of this disclosure. The embodiment of the gesture vocabulary 800 shown in FIG. 8 is for illustration only, and other embodiments can be used without departing from the scope of this disclosure.

The gesture vocabulary 800 includes a pair of circles, a pair of pinches, and a pair of swipes. The pair of circles contains a radial circle gesture 802 and a tangential circle 804. The names radial and tangential come from the movement of the finger relative to the radar. As the name implies in the radial circle gesture 802, the movement of the finger is radial to the radar, whereas in the tangential circle gesture 804, the movement is tangential to the radar. The pair of pinches includes a single pinch gesture 806 and a double pinch gesture 808. The pair of swipes includes two directional swipes, including a left-to-right swipe gesture 810 and a right-to-left swipe gesture 812.

Each of the circle gestures 802 and 804 corresponds to a gesture length l_{circle} based on the four finger positions that compose the circle gesture. The single pinch gesture 806 corresponds to a gesture length l_{pinch1} based on the three finger positions that compose the gesture. The double pinch gesture 808 corresponds to a gesture length l_{pinch2} based on the five finger positions that compose the gesture. Each of the swipe gestures 810 and 812 corresponds to a gesture length l_{swipe} based on the two finger positions that compose the swipe gesture. As a comparison, l_{pinch2}>l_{circle}>l_{pinch1}>l_{swipe}, and each represents an expected a quantity (or range) of frames for a user to start and complete performance of the corresponding gesture. Also, the gesture length l_{pinch2} of the double pinch 808 can be at least double the length l_{swipe} of the swipe gesture 810, 812.

Although FIG. 8 illustrates one example gesture vocabular 800, various changes can be made to FIG. 8. For example, the gesture vocabulary 800 can include more or fewer gestures. As a particular example, the gesture vocabulary 800 could include other gestures, such as: (i) an index extension in which the index finger is extended towards the radar and is subsequently contracted; (ii) clockwise circle; (iii) counter-clockwise circle; (iv) left-half circle; (v) right-half circle; (vi) a slide of thumb on index finger; (vii) an open only gesture that starts from thumb and index fingers touching and includes movement of separating them; and (viii) a close only gesture that starts from the separated thumb and index fingers and includes movement of touching them.

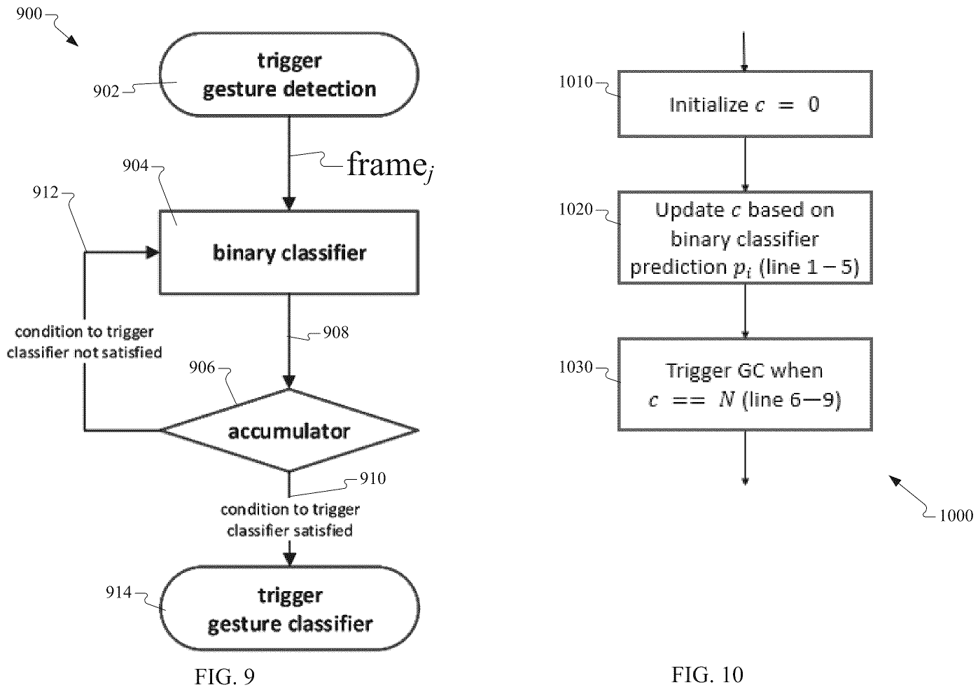

FIG. 9 illustrates an example end-detection method 900 executed by the ADM in accordance with an embodiment of this disclosure. As described more particularly below, the method 900 exhibits a bottleneck of that is a source of latency for the end-to-end gesture recognition system 700 of FIG. 7. The embodiment of the end-detection method 900 shown in FIG. 9 is for illustration only, and other embodiments can be used without departing from the scope of this disclosure.

The end-detection method 900 begins at block 902, at which the gesture detection mode is triggered by the gesture mode triggering mechanism 710. The end-detection method 900 is based on a binary classifier 904 followed by an accumulator 906. One function of the accumulator 906 is to accumulate the predictions (pⱼ) 908 of the binary classifier 904. Another function of the accumulator 906 is to determine whether a predetermined accumulation condition to trigger the GC 730 is satisfied. For example, the accumulation condition can be satisfied if the binary classifier 904 outputs a threshold number of gesture-is-complete determinations/predictions within a specified duration of time (e.g., within a specified number of frames). That is, in response to a determination that the accumulation condition to trigger the GC 730 is satisfied, the accumulator 906 generates an indicator 910 indicating the accumulation condition to trigger the GC is satisfied. As long as the accumulation condition is not satisfied (as shown by the arrow 912), the operation of the binary classifier 904 and the accumulator 906 continues or repeats. At block 914, in response to a determination that the accumulation condition to trigger the GC 730 is satisfied, the ADM triggers the GC 730 based on the indicator 910.

In certain embodiments, the binary classifier 904 and accumulator 906 are components of the ADM 720, which is a data-driven solution. The binary classifier 904 can be the same as or similar to the binary classifier 722 of FIG. 7. More particularly, the binary classifier 904 can receive the extracted features 715 from the feature extractor 740 of FIG. 7.

The binary classifier 904 processes frames of radar data, and each frame (illustrated as frame) can have an index i. The frames of radar data can be frames of extracted features 715, such as power weighted Doppler normalized by maximum (PWDNM), which is derived from TVD. The binary classifier 904 is trained to distinguish whether frame, is the gesture end using a PWDNM feature. The trained binary classifier 904 is inclined to interpret a trend of energy dropping at the end as an end of a gesture and output a gesture end indicator. The prediction (pᵢ) 908 of the binary classifier has two alternative outcomes: “class 0”— meaning gesture has not ended; and “class 1”—meaning gesture has ended. More generally, when the binary classifier 904 outputs “class 1” in relation to frameᵢ, also a gesture end indicator is related to that frameᵢ.

The purpose of the accumulator 906 is to increase robustness of the prediction of the binary classifier 904, and the accumulator 906 declares a gesture end is detected by the ADM when the accumulator 906 has enough confidence. These predictions output from the binary classifier 904 are then collected through the accumulator 906. The accumulator 906 increases the confidence if the number of number of gesture-is-complete determinations output by the binary classifier 904 increases or increases within the specified duration or in specified number of frames.

The rationale for accumulating predictions is twofold, accordingly, the accumulator 906 solves two technical problems: (1) the binary classifier 904 is imperfect and may occasionally misdetect (e.g., fail to detect or incorrectly detect) the gesture end for a frame; and (2) the binary classifier 904 may detect a gesture end too early, especially when there is a pause duration within the gesture. Firstly, as an example of misdetection, the binary classifier 304 occasionally predicts that the gesture has ended, whereas, in reality, the gesture has not ended (i.e., user has not completed performance of the gesture). As another example of misdetection, sometimes the radar data may include some small finger perturbation after a gesture has been performed, which may affect the detection of the gesture end, and which may cause the binary classifier 904 to interpret the perturbation as gesture activity.

Secondly, some delay is required to make sure that the gesture has ended in reality. To this end, a good example is the case of “Single Pinch” gesture 806 and “Double Pinch” gesture 808. The “Double Pinch” inherently contains two “Single Pinch” gestures. If the user intends to perform a “Double Pinch” gesture 808, and if there is no delay after the first pinch (i.e., the GC 730 is triggered by the prediction 908 without the intermediate accumulator 906), then GC 730 will be triggered, and will determine that a “Single Pinch” gesture 806 was performed. In contrast, if the accumulator provides enough delay, then the user will start the second pinch of the “Double Pinch” gesture 808, and hence only after the user completes the whole “Double Pinch” gesture, the GC 730 will be triggered.

As an example of detecting a gesture end too early, a single or double pinch gesture may include a pause duration while the thumb and index finger are touching (i.e., in a closed state). When a person switches the status of the index finger and thumb between open and closed, the radar data may include energy dropping patterns in the middle of the gesture, which may cause the binary classifier 904 to interpret the pause duration (e.g., energy dropping pattern) as the end of the gesture. In reality, however, the pinch gestures 806 and 808 (FIG. 8) end when the thumb and index finger are separated (i.e., in an open state) by at least a distance.

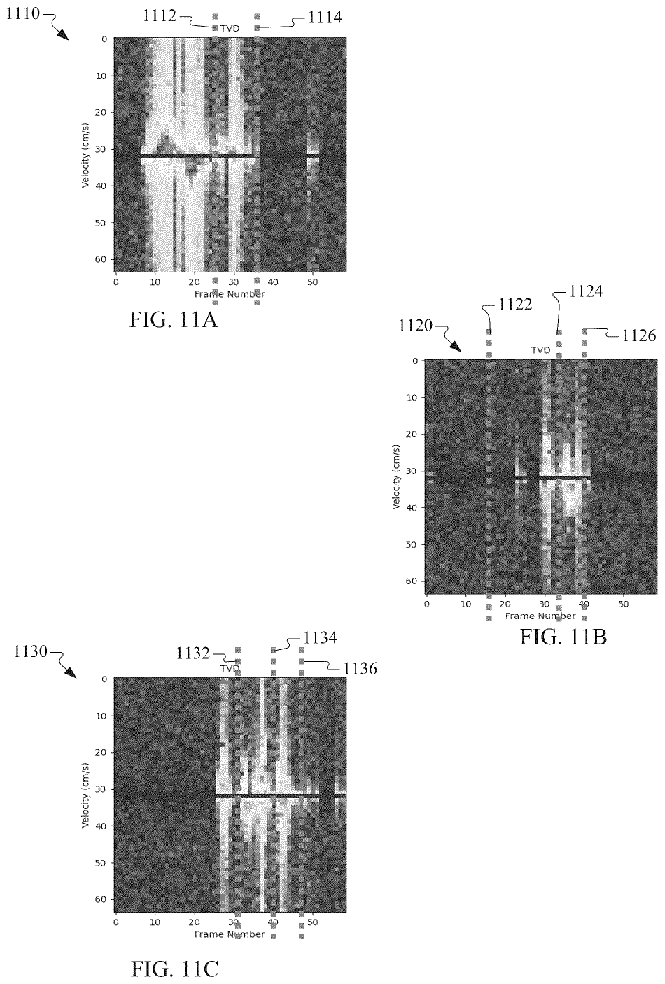

As examples of energy dropping patterns, FIG. 11A shows a TVD 1110 of a single pinch gesture, a first gesture end indicator 1112 at an energy dropping pattern based on the index finger and thumb in the closed state (e.g., at frame 25), and a second gesture end indicator 1114 at an energy dropping pattern based on the index finger and thumb in the open state (e.g., at frame 35). As additional examples of energy dropping patterns, FIG. 11C shows a TVD 1130 of a double pinch gesture, a first gesture end indicator 1132 based on the index finger and thumb in the closed state (e.g., at frame 32), and a second gesture end indicator 1134 based on the index finger and thumb in the open state (e.g., at frame 40), and a third gesture end indicator 1136 based on the index finger and thumb in the closed state (e.g., at frame 48). Some delays are needed to ensure that it a true gesture end is detected. To solve these two technical problems of binary classifier 904 misdetection and premature detection, FIG. 10 shows details of this fixed-duration accumulator algorithm 1000 (also referred to as “Algorithm 1”).

FIG. 10 illustrates a fixed-duration accumulator algorithm 1000 implemented as part of the end-detection method 900 of FIG. 9 in accordance with an embodiment of this disclosure. The embodiment of the fixed-duration accumulator algorithm 1000 shown in FIG. 10 is for illustration only, and other embodiments can be used without departing from the scope of this disclosure.

The fixed-duration accumulator algorithm 1000 is shown as both a series of steps in Table 2 and as a series of flowchart blocks in FIG. 10. Each of the flowchart blocks in FIG. 10 corresponds to a subset of the steps in Table 2. Particularly, to execute the fixed-duration accumulator algorithm 1000, the accumulator 906 initializes a counter c at block 1010, updates the counter c at block 1020, and triggers the GC 730 based on the updated counter c at block 1030.

TABLE 2
Algorithm 1: Fixed-duration Accumulator Algorithm

| Initialization | : c ← 0 |
|---|---|
| Input | : pᵢ |
| 1 | : if pᵢ = = 1: then |
| 2 | : c ← c + 1 |
| 3 | : else if pᵢ = = 0: then |
| 4 | : c ← max(c − 1,0) |
| 5 | : end if |
| 6 | : if c = = N then |
| 7 | : Trigger the gesture classifier |
| 8 | : c ← 0 |
| 9 | : end if |

Block 1010 corresponds to an initialization step, at which the counter c is set to a zero value (c=0 or c←0). In certain embodiments, block 1010 additionally corresponds to an input step, at which the accumulator 906 receives a prediction (pᵢ) 908 from the binary classifier 904.

Block 1020 corresponds to steps 1-5. At step 1, if the prediction (pᵢ) 908 is a “class 1” prediction, then at step 2, the counter c is incremented. At step 3, if the prediction (pᵢ) 908 is “class 0”, then at step 4, the counter c is decremented. Step 5 ends the procedures of block 1020.

Block 1030 corresponds to steps 6-9. At step 6, whenever the counter c reaches the value N of a counting threshold, then at step 7, the GC 730 is triggered, and at step 8, the counter c is reset to 0 to enable the ADM 720 monitor for a subsequent gesture. Particularly, at step 6, the accumulator 906 determines whether an accumulation condition to trigger the GC 730 is satisfied (c==N). The counting threshold N is a parameter that provides a trade-off (e.g., balance) between accuracy and delay, and represents a predetermined number of gesture-is-complete determinations/predictions. The procedure performed at step 7 is the same as the procedure performed at block 914 of FIG. 9. Step 9 ends the procedures of block 1030.

In FIGS. 9 and 10, the runtime of the binary classifier 904 is negligible, and the latency is mainly due to the accumulator 906. Even examining the entire pipeline of the end-to-end gesture recognition system 700 of FIG. 7, the runtime of signal processing and GC 730 are also negligible compared to the accumulator 906. As described above, the accumulator 906 serves to avoid misdetection of a gesture and premature detection of a gesture (i.e., before it ended) which may cause the misclassification of the gesture. To maintain the high performance in this scheme, a design choice may be a large N value. In one non-limiting experiment, N=11 radar frames and a radar frame duration may be 46 ms, which means the wait time before the gesture end can be declared is 11×46=506 ms in a typical case. This non-limiting experiment shows that the large latency of this fixed-duration accumulator algorithm 1000 is caused by the accumulator 906. In this disclosure, the latency problem caused by the accumulator 906 is solved by new systems and methods of FIGS. 12-27 to reduce the latency while maintaining the high accuracy.

FIGS. 11A, 11B, and 11C illustrate a prediction of an end of a gesture as determined by a binary classifier based on various examples of a time-velocity data (TVD) in accordance with an embodiment of this disclosure. For example, FIG. 11A shows a TVD 1110 of a single pinch gesture and gesture end indicators 1112 and 1114. Each gesture end indicator indicates a particular frame (e.g., frame numbers 25 and 35) that the binary classifier 904 classified as “class 1” (e.g., predictions p₂₅=p₃₅=“class 1”), which classification indicates an end of the gesture occurred at that frame number. As an example, each gesture end indicator is displayed as a dashed vertical line overlayed the TVD, as such, the column that represents the corresponding frame number is overlapped (e.g., highlighted). That is, the gesture end indicator is displayed as visual representation of a “class 1” prediction. FIG. 11B shows a TVD 1120 of a clutter and gesture end indicators 1122, 1124, and 1126. FIG. 11C shows a TVD 1130 of a double pinch gesture and gesture end indicators 1132, 1134, and 1136 that correspond to predictions p₃₂=p₄₀=p₄₈=“class 1”. The embodiments of the TVDs 1110, 1120, and 1130 and corresponding gesture end indicators shown in FIGS. 11A-11C are for illustration only, and other embodiments can be used without departing from the scope of this disclosure.

FIG. 12 illustrates an early stop checker 1202 within an end-detection method 1200 executed by the ADM in accordance with an embodiment of this disclosure. The early stop checker 1202 is the same as the early stop checker 724 of FIG. 7. The block 902, binary classifier 904, accumulator 906, and block 914 of FIG. 12 can be the same as described above with FIG. 9. The embodiment of the end-detection method 1200 with the early stop checker 1202 shown in FIG. 12 is for illustration only, and other embodiments can be used without departing from the scope of this disclosure.

The end-detection method 1200 of FIG. 12 can be compared to the end-detection method 900 of FIG. 9. The end-to-end gesture recognition system 700 can provide high recognition accuracy with the end-detection method 900 of FIG. 9, which enables the ADM to be highly accurate to detect when a desired gesture was conducted. While accurate, one main issue of this the end-detection method 900 of FIG. 9 is its large latency, which is due to employing a counting mechanism that requires a delayed decision for a long duration, and which may be too large of a latency to be used generate a prompt response required by gestural applications. To increase robustness of the detection of the end of a gesture, the end-detection method 1200 with the early stop checker 1202 shown in FIG. 12 is able to reduce the latency compared to the end-detection method 900 of FIG. 9, while maintaining or even improving the accuracy of end-to-end gesture recognition system 700.

The early stop checker 1202 is able to analyze a sliding window of radar data (“data window”), and the data window can include 50 frames of radar data in certain embodiments. The early stop checker 1202 is configured to adaptively check whether any noise frames are at the end of gesture activity and also confirm that a valid activity is in a data window. In response to a determination that the early stop conditions are satisfied, the early stop checker 1202 triggers the GC 730 immediately (i.e., early stop), without waiting until the accumulator 906 determines that counting threshold is reached (i.e., c==N) to reduce latency. The early stop checker 1202 checks whether the early stop conditions are satisfied, which satisfaction causes the early stop checker 1202 to generate an indicator 1204 that the early stop condition is satisfied. The early stop indicator 1204 enables the ADM to trigger the GC 730 before the accumulation condition is satisfied.

Instead of using a fixed counting threshold Nin the accumulator 906 for all the data samples, the early stop checker 1202 is a technical solution that applies adaptive rules to determine the gesture end. The early stop checker 1202 enables the method 1200 to not need to use a large counting threshold N for all the gesture samples. The early stop checker 1202 receives the predictions (pⱼ) 908 from the binary classifier 904, and is triggered when the binary classifier predicts “class 1.” A prediction 908 of “class 1” indicates to the early stop checker 1202 that energy dropping is being detected by the radar transceiver and that a gesture is ending (e.g., coming to an end), and triggers the early stop checker 1202 to determine whether the early stop condition is satisfied. In response to detecting a prediction 908 of “class 0,” the early stop checker 1202 is not triggered. There early stop checker 1202 can be designed in different ways, and one design is shown in FIG. 13.

FIG. 13 illustrates a method 1300 of an early stop checker in accordance with an embodiment of this disclosure. Together, the blocks 1310 and 1320 of FIG. 13 compose the early stop checker 1202 of FIG. 12. The embodiment of the method 1300 shown in FIG. 13 is for illustration only, and other embodiments can be used without departing from the scope of this disclosure.

In response to being triggered by the prediction 908 of “class 1,” the early stop checker 1202 will use both the signal features and status of the accumulator 906 to determine whether to trigger the GC 730 (block 914). For ease of exposition, the frames from the gesture start (i.e., where user starts to perform a gesture) to gesture end (i.e., where user finishes performance of the gesture) are referred to as “signal frames;” and the frames outside this range are referred to as “noise frames.”

At block 1310, to confirm a gesture end, the early stop checker 1202 adaptively checks whether the last few frames of the input data window are noise frames. Particularly, in order to avoid triggering the GC 730 based on noise frames occurring in the middle of a gesture, the early stop checker 1202 determines whether the noise frames are occurring at the end of a gesture. There are also various ways to identify noise frames versus valid activities. One way for the early stop checker 1202 to identify a noise frame is to check if energy level of a frame, is below a threshold. That is, the noise frame has an energy level below the threshold, but if the energy level of the frame, is greater than or equal to the threshold, then the frame contains valid activity (i.e., valid activity).

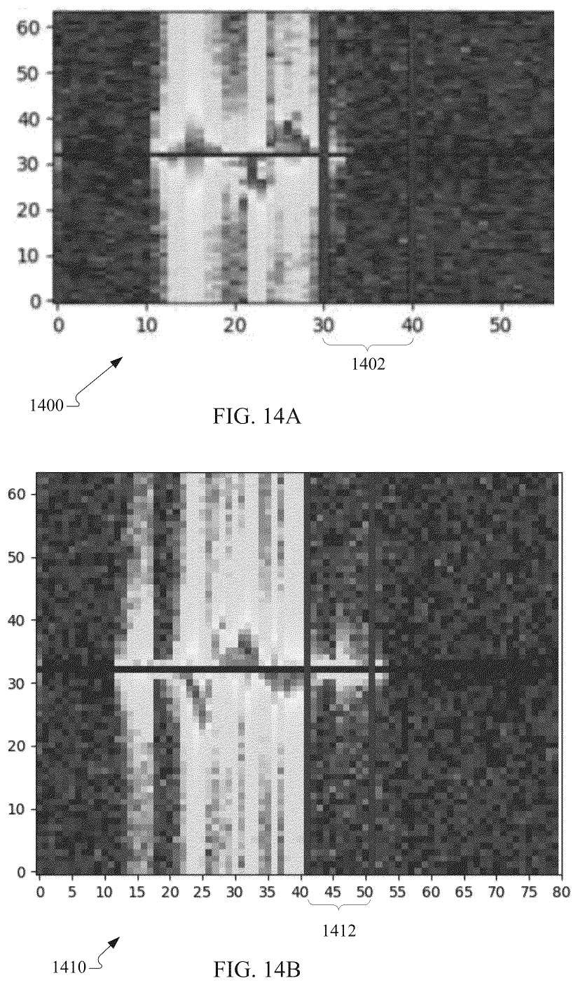

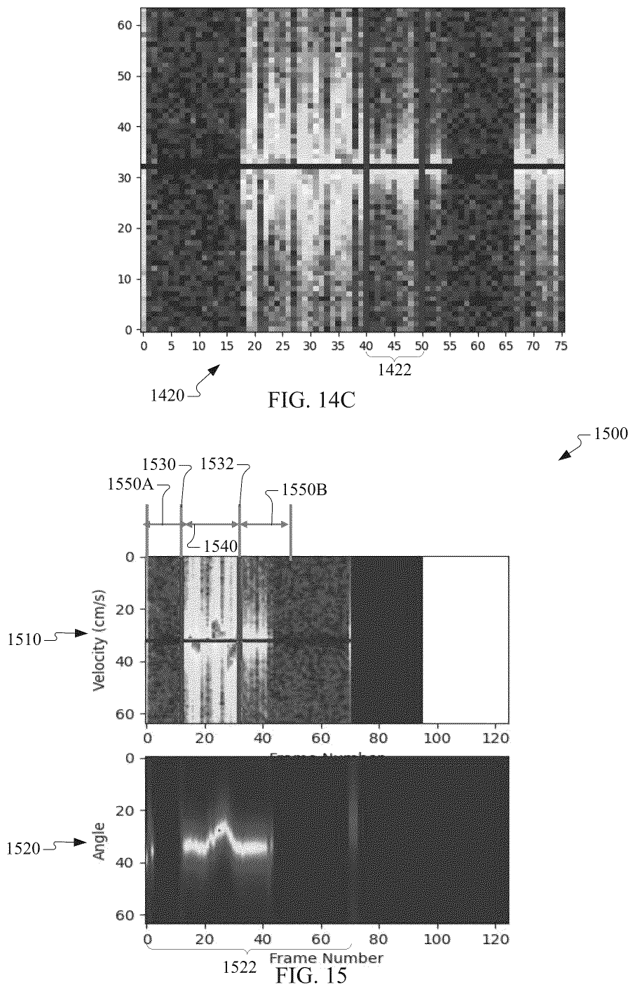

For example, the early stop checker 1202 not limited to only check whether the last few frames are noise frames. The early stop checker 1202 avoids triggering the GC 730 based on data samples without valid activity, which may contain only noise or non-gesture activities. Sometimes even a data window that does not have gesture motion (for example, if an entire data window looked like framer₅₅-frame₈₀ of FIG. 14B) may be predicted as a gesture end by the binary classifier 722. Block 1320 provides a technical solution for those cases, wherein the early stop checker 1202 determines whether the data window satisfies validity conditions, for example by checking to make sure enough signal frames are contained in the data window. For ease of explanation, block 1320 is also referred to as a “valid activity checker.”

Within the early stop checker 1202, the valid activity checker 1320 checks whether the data window (e.g., most recent 50 frames) contains a valid activity. Particularly, early stop checker 1202 avoids a false alarm of prematurely triggering the GC 730 based on detection of clutter samples, or a data sample that contains only noise frames or non-gesture activities. In response to determinations that conditions of both blocks 1310 and 1320 are satisfied, the early stop checker 1202 triggers the GC 730, as shown at block 914.

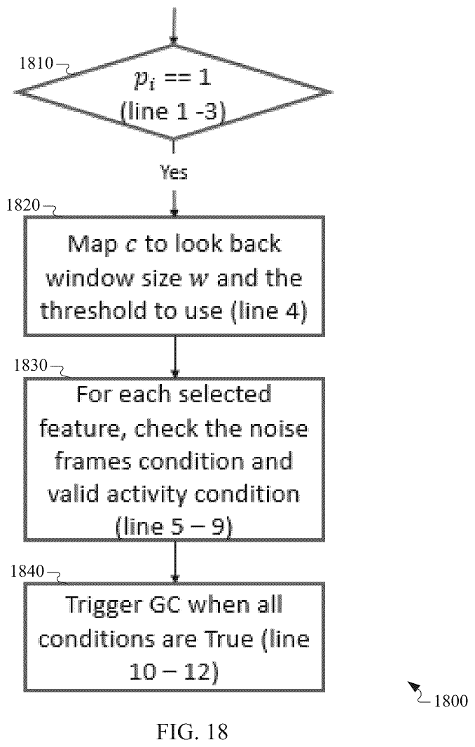

Although FIG. 13 illustrates one example method 1300 of an early stop checker, various changes can be made to FIG. 13. As a particular example of block 1310, FIGS. 15-17 show another way for the early stop checker 1202 to identify a noise frame. As a particular example of the valid activity checker 1320, another way to identify a frame that contains valid activity, is described further below with Algorithm 2 of FIG. 18, which uses adaptive thresholds based on the status of accumulator 906, which status is indicated by the counter c in the accumulator 906. For simplicity, the counter c is also referred to as accumulator status c.

FIGS. 14A, 14B, and 14C illustrate various examples of a data window of radar data that includes a gesture with different types of ends of a gesture, in accordance with an embodiment of this disclosure. Some gestures have a clear end as shown in FIG. 14A, and other gestures may have a tails at the end caused by finger perturbation or noise as shown in FIGS. 14B and 14C. In certain embodiments, the length of the data window 1400, 1410, 1420 can be all of the frames shown. In certain embodiments, the length of the window is a subset of the frames shown, for example, from frame₁ and frame₅₀.

FIG. 14A illustrates a data window 1400 of radar data that includes a clear end 1402 of the gesture between frame₃₀ and frame₄₀. For example, if the binary classifier detects where energy decreases (for example, shown from frame₃₀ to frame₃₃), and if the early stop checker 1202 identifies that the last few frames of the data window 1400 are noise frames (e.g., the clear end 1402), then the ADM confirms that the last few noise frames are clearly the end of the gesture. In the case of a clear end 1402, the early stop checker 1202 can trigger the GC 730 prior to (e.g., without) the accumulation condition being satisfied.

FIG. 14B illustrates a data window 1410 of radar data that includes a tail 1412 of noise at the end of the gesture between frame₄₁ and frame₅₁. The tail 1412 of noise frames represent finger perturbation, which is some movement that the user performed unintentionally after completing performance of the gesture.

FIG. 14C a data window 1420 of radar data that includes clutter samples, namely as a mixture of noise frames and signal frames such that the number of signal frames is less than a data window threshold. If the number of signal frames is less than the data window threshold (e.g., 3), then no valid gesture is identified. The early stop checker 1202 might be challenged to accurately distinguish noise frames versus signal frames based on this mixture within the TVD of the data window 1420. To identify whether a noise frame is at the end of a gesture, the early stop checker 1202 may look into the feature difference of signal frames and noise frames, as described further with the FIG. 15.

FIG. 15 illustrates extracted features 1500 including TVD 1510 and TAD 1520 for the same period of time, particularly, frame₁ to frame₁₂₅, which includes a data window 1522 of radar data. The embodiment of the extracted features 1500 shown in FIG. 15 is for illustration only, and other embodiments can be used without departing from the scope of this disclosure. As introduced above at block 1310 of FIG. 13, the ADM 720 identifies the gesture start 1530, the frame at which user starts to perform a gesture; and the ADM 720 (including the early stop checker 1202) identifies the gesture end 1532, the frame at which the user finishes performance of the gesture. The set of frames 1540 from the gesture start 1530 to gesture end 1532 are referred to as “signal frames;” and the frames 1550a and 1550b outside this range are referred to as “noise frames.” For some frames, signal frames 1540 are easier to distinguish from the noise frames 1550a and 1550b based on the TAD 1520 than based on the TVD 1510.

The early stop checker 1202 is designed to tradeoff (e.g., balance) the possibility of early detections, which occur in the middle of a gesture, and also the possibility of misdetections/late detections, which occur after a gesture ends. The noise frames 1550a before the gesture start 1530 and the noise frames 1550b after the gesture end 1532 are either noise frames without any finger motion or noise frames with small finger perturbation/shaking. The case of small finger perturbation/shaking occurs frequently happens in many gesture samples. Particularly within the noise frames 1550b of the TVD 1510, the radar data demonstrates some finger perturbation, hand shaking or other noise after the gesture end 1532.

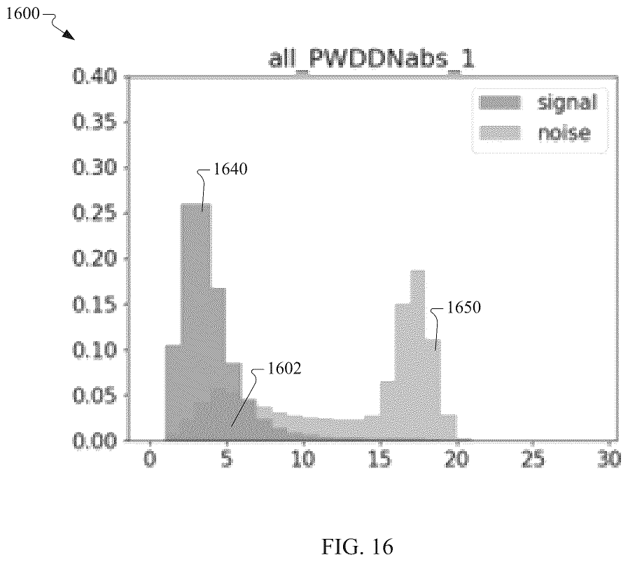

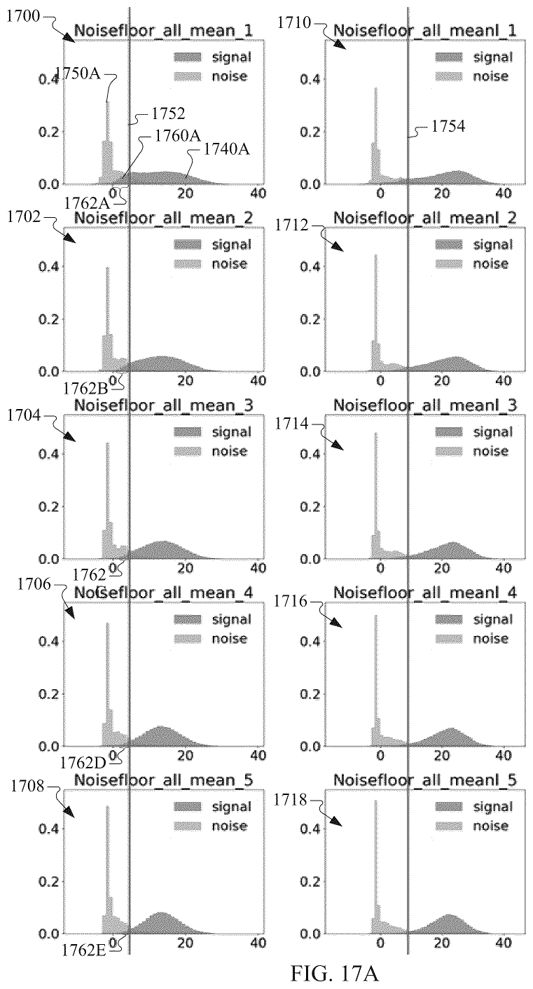

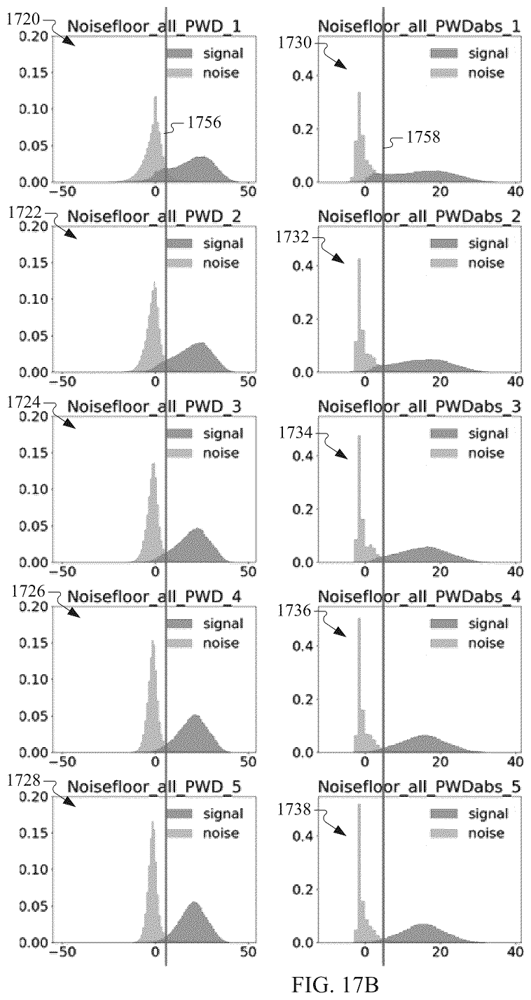

As shown in FIGS. 16 and 17, to completely differentiate noise frames with signal frames is not trivial. There are many features that could be extracted and used to differentiate signal frames and noise frames, including, by not limited to the following four parameters: (1) mean in Doppler dimension in log scale (Mean); (2) mean in the linear scale (Meanl); (3) power weighted Doppler (PWD); and (4) power weighted absolute Doppler (PWDabs).

FIG. 16 illustrates a histogram of power weighted absolute Doppler with Doppler normalization (PWDDNabs) features 1600 extracted from radar data in accordance with an embodiment of this disclosure. The embodiment of the PWDDNabs features 1600 shown in FIG. 16 are for illustration only, and other embodiments can be used without departing from the scope of this disclosure. The PWDDNabs features 1600 are another example of features that could be extracted, but FIG. 16 demonstrates that the PWDDNabs features 1600 are found not suitable for signal frames and noise frames differentiation. For example, an overlap area 1602 shows that all of the signal frames 1640 overlap the noise frames 1650 by at least some amount.

FIG. 17A and FIG. 17B (together FIG. 17) illustrate histograms of different extracted features 1700-1738 with different lookback windows, in accordance with an embodiment of this disclosure. From the first row to the fifth row, the lookback window is from w=1 to w=5. The columns from left to right are corresponding to feature Mean, Meanl, PWD, PWDabs, respectively. Each column shows one feature. Particularly, FIG. 17A illustrates the first column of the histograms of Mean features 1700, 1702, 1704, 1706, 1708 and the second column of the histograms of Meanl features 1710, 1712, 1714, 1716, 1718 extracted from radar data; and FIG. 17B illustrates the third column of the histograms of PWD features 1720, 1722, 1724, 1726, 1728 and the fourth column of the histograms of PWDabs features 1730, 1732, 1734, 1736, 1738 extracted from radar data. The features of all the signal frames and noise frames are calculated, and a legend denotes signal frames 1740 and noise frames 1750. The red line is an example feature threshold 1760, 1770, 1772, and 1774. The portion of signal less than the feature threshold become smaller as the lookback window increases, for each feature. The embodiment of the histograms shown in FIG. 17 is for illustration only, and other embodiments can be used without departing from the scope of this disclosure.

To calculate these extracted features, the TVD in dB is denoted according to Equation 30, TVD in linear scale is denoted according to Equation 31, and the four features (i.e., Mean, Meanl, PWD, and PWDabs) are calculated for frame j.

T∈N_{c}×F (30)

Tₗ∈N_{C}×F (31)

To directly use those features calculated from TVD, a noise floor is subtracted from each extracted feature: the Mean, Meanl, PWD, PWDabs, respectively. Ideally noise frames are close to the noise floor. When the radar configuration is changed, the noise floor may also change. By subtracting the noise floor, the extracted features may become more invariant to the radar configuration. The noise floor is estimated from a Range Doppler Map (RDM), where RDM in dB is denoted according to Equation 32, and the RDM in linear scale denoted according to Equation 33. The same feature is calculated on the RDM, and the median value is used as the noise floor.

R∈N_{c}×Nₛ (32)

Rₗ∈N_{c}×Nₛ (33)

Other methods to calculate the noise floor may also be used. Below are the equations for computing these features.

$$Median ( in dB ) : μ [ j ] = \frac{1}{64} {\sum }_{k} T [ k , j ] - n [ j ] \qquad ( 34 )$$

$$Noise floor : n [ j ] = {median}_{i} ( \frac{1}{64} {\sum }_{k} {R}_{l} [ k , i ] ) \qquad ( 35 )$$

$$Meanl ( in linear scale ) : {μ}_{ℓ} [ j ] = 10 {log}_{10} ( \frac{1}{64} {\sum }_{k} {T}_{ℓ} [ k , j ] ) - {n}_{l} [ j ] \qquad ( 36 )$$

$$Noise floor : {n}_{l} [ j ] = 10 {log}_{10} ( {median}_{i} ( \frac{1}{64} {\sum }_{k} {R}_{l} [ : , i ] ) ) \qquad ( 37 )$$

$$PWD : {d}_{1} [ j ] = 10 {log}_{10} ( \vert \frac{1}{64} {\sum }_{k = - 32}^{31} {kT}_{l} [ k , j ] \vert ) - {n}_{{d}_{1}} [ j ] \qquad ( 38 )$$

$$Noise floor : {n}_{{d}_{1}} [ j ] = 10 {log}_{10} ( \vert {median}_{i} ( \frac{1}{64} {\sum }_{k = - 32}^{31} {kT}_{l} [ k , i ] ) \vert ) \qquad ( 39 )$$

$$PWDabs : {d}_{2} [ j ] = 10 {log}_{10} ( \frac{1}{64} {\sum }_{k = - 32}^{31} \vert k \vert {T}_{l} [ k , j ] ) - {n}_{{d}_{2}} [ j ] \qquad ( 40 )$$

$$Noise floor : {n}_{{d}_{2}} [ j ] = 10 {log}_{10} ( {median}_{i} ( \frac{1}{64} {\sum }_{k = - 32}^{31} \vert k \vert {T}_{l} [ k , i ] ) ) \qquad ( 41 )$$

As introduced above, for each feature, the portion of signal frames less than the feature threshold decreases as the size of the lookback window increases. That is, the portion of signal frames less than the feature threshold is inversely proportional to the size of the lookback window. For example, as shown in the first column of the histograms of Mean features shown in FIG. 17A, an overlap area 1760a is where the signal frames 1740a overlap the noise frames 1750a, but a majority of the signal frames 1740a do not overlap the noise frames 1750a, and the portion 1762a of the signal frames 1740a less than (e.g., left of) the feature threshold 1760 constitutes a minority of the signal frames 1740a. The portion 1762a, from among the signal frames 1740a that are less than the feature threshold 1760 and in the first row case of w=1, is greater than the other portions 1762b, 1762c, 1762d, and 1762e, respectively, which correspond to the other cases of w=2, w=3, w=5, and w=5, respectively.

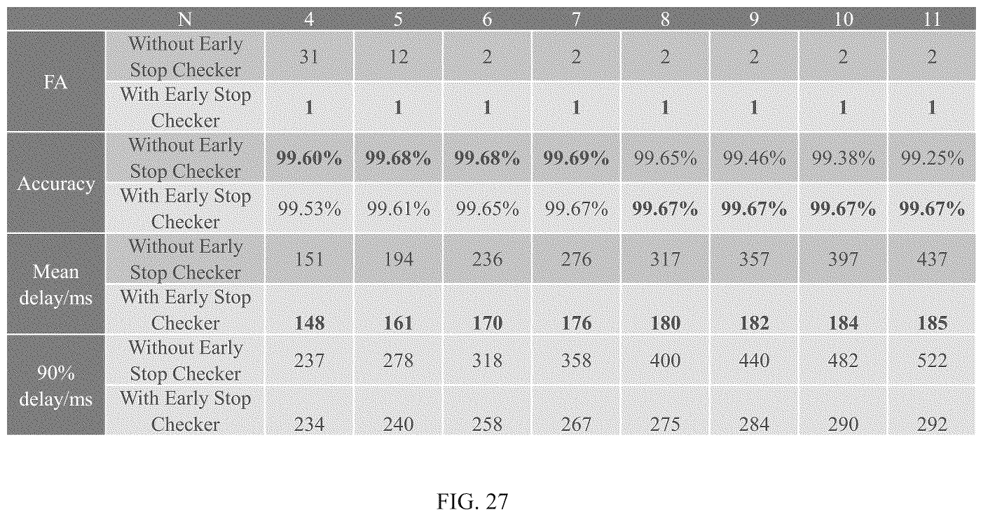

Additionally, a lookback window w can be setup for each frame to hold the sequential features. For example, the Mean feature of frame j with lookback window w is denoted as μ[j−w:j]. Based on the limitation of computation resources, all of the features are used in certain embodiments that have greater computation resources, or a subset of the features is used in other embodiments that have lesser computation resources. Experiments according to this disclosure have demonstrated that using all the four features generates better accuracy but longer latency. The advantages and disadvantages of using different features are also described further below with FIGS. 27-32, which describe examples of effectiveness.

Further, to set up conditions using these features to differentiate noise frames from signal frames, this disclosure provides a data-driven approach to select the feature thresholds 1760-1774. Embodiments of this disclosure analyzes the feature difference of signal frames and noise frames on a large dataset. For each gesture sample, the frames between a manually labeled gesture start (e.g., 1530 of FIG. 15) and a manually labeled gesture end (e.g., 1520 of FIG. 15) define signal frames, and 10 frames before the gesture start define noise frames, and 10 frames after the gesture end also define noise frames. The signal and noise histograms of the different features are shown in FIG. 17, and the mean value can be used to represent the feature with lookback window larger than 1. As the size of the lookback window w increases, the noise frames 1750 and signal frames 1740 become more separable.

However, there is some overlapping region (for example, 1760a) between signal frames and noise frames, which means that embodiments of this disclosure carefully select the feature threshold 1760 to tradeoff (for example, balance) the misdetection of the signal frames (MDSF) and the false alarm of noise frames (FANF). The MDSF are the signal frames less than feature threshold, and the MDSF may cause the ADM to perform premature (e.g., too early) detection. The FANF are the noise frames larger than the feature threshold, and the FANF may cause longer latency for the ADM. The histograms of a single extracted feature (e.g., Mean features 1700, 1702, 1704, 1706, and 1708) with differently sized lookback windows share a fixed feature threshold (e.g., 1760). Particularly, the feature threshold 1770 is shared by the histograms of Meanl features 1710-1718; the feature threshold 1772 is shared by the histograms of PWD features 1720-1728, and the feature threshold 1774 is shared by the histograms of PWDabs features 1730-1738. If a fixed feature threshold is used for different sizes of the lookback window, then the MDSF may be too large for small w or too small for large w. In certain embodiments different feature thresholds are used for different sizes of the lookback window. To determine (e.g., define or select) a feature threshold with low impact on the accuracy of the ADM, a low MDSF could be targeted. For example, MDSF from 0.1% to 2% may be used. Alternatively, in the case of a large MDSF, the accuracy of the ADM decreases, and the latency reduces. The impacts on the accuracy and latency of the ADM resulting from choosing different MDSF are described further below with FIGS. 27-32, which describe examples of effectiveness.

Although FIG. 17 illustrates an embodiment in which fixed feature thresholds 1760, 1770, 1772, 1774 are respectively applied to the extracted features Mean, Meanl, PWD, PWDabs, respectively, various changes can be made to FIG. 17. For example, various components in FIG. 17 can be changed according to particular needs. As a particular example, instead of using a fixed feature threshold for each feature, embodiments of this disclosure use adaptive feature thresholds for different lookback window sizes. Rules can be used to select the adaptive feature thresholds that are mainly based on the MDSF. The ADM 720 determines, based on the accumulator status c, the value of w as the number of frames to lookback and the corresponding feature thresholds to use. The embodiments of this disclosure aim to reduce the latency while maintaining accuracy, so a small MDSF is selected as a basis from which to determine the adaptive feature threshold for different featured and different sizes of lookback windows. For example, if the ADM 720 selects MDSF=0.5%, then fₜₕ[ft][w] denotes the corresponding feature thresholds for each feature with a lookback window size w from 1 to 7. The feature type is denoted as ft, and the size of the lookback window is 1≤w≤7. For example, in the case of the first column of Mean features 1700-1708 in FIG. 17A, the MDSF=0.5% means that 0.5% of the signal frames 1740a are less than the feature threshold. After the accumulator status c is determined, then the early stop checker 1202 lookbacks min(c, 7) frames of each feature and uses the corresponding feature threshold fₜₕ[ft][c] to determine (e.g., check) whether there are noise frames at the end or not. The rationale to setup adaptive feature threshold is that the counter c carries the information that binary classifier 904 predicts “class 1” continuously for c frames, wherein ideally there are c noise frames. As the counter c becomes larger, the ADM can adaptively set a larger feature threshold to identify noise frames distinguished from signal frames as indicated from the histograms shown in FIG. 17.

The experiments of this disclosure demonstrate that when the ADM 720 executes uses all 4 features (from the feature set {Mean, Meanl, PWD, PWDabs}) together, the ADM improves the accuracy but also increases the latency. In certain embodiments, a designer of the ADM 720 can select a subset from the feature set or add additional features based on requirements of the application (e.g., a gestural application). For example, if the ADM 720 selects a subset from the feature set, then the accuracy and latency of ADM 720 will be as follows: accuracy of PWD>accuracy of Meanl>accuracy of PWDabs; accuracy of Meanl>accuracy of mean; latency of PWD>latency of Mean>latency of Meanl>latency of PWDabs. Among the four features, if only one feature is selected as the subset to reduce latency while maintaining accuracy, then the PWD feature (i.e., third column in FIG. 17B) exhibits the best accuracy while having longer latency than the other features.

FIG. 18 illustrates a valid activity identification algorithm (“Algorithm 2”) 1800 implemented as part of the valid activity checker 1320 of FIG. 13 in accordance with an embodiment of this disclosure. This disclosure provides additional details about the choices of the features and the corresponding thresholds. The early stop checker 1202 executes the valid activity identification algorithm 1800 as a way to identify frames that contain valid activities versus noise frames. The embodiment of the valid activity identification algorithm 1800 shown in FIG. 18 is for illustration only, and other embodiments can be used without departing from the scope of this disclosure.

The valid activity identification algorithm 1800 is shown as both a series of steps in Table 3 and as a series of flowchart blocks in FIG. 18. Each of the flowchart blocks in FIG. 18 corresponds to a subset of the steps in Table 3. Particularly, execution of the valid activity identification algorithm 1800 includes: initializing variables at block 1810; determining a respective feature thresholds for each of the selected features at block 1820, determining whether the early stop conditions are satisfied at block 1830, and triggering the GC 730 in response to a determination the early stop conditions are satisfied that at block 1840.

TABLE 3
Algorithm 2: Valid Activity Identification Algorithm

| Initialization | : stop ← True, validactivity ← True, fₜₕ ← {“mean”: |
|---|---|
| | meanth, “meanl”: meanlth, “pwd”: pwdth, “pwdabs”: |
| | pwdabsth} |
| Input | : pᵢ, c, T, NF, selected_features, wₘₐₓ |
| 1 | : if pᵢ = = 0: then |
| 2 | : return False |
| 3 | : end if |
| 4 | : idx = min(c − 1, wₘₐₓ − 1) |
| 5 | : For ft in selcted_features: |
| 6 | : feature = calculate_feature(ft, T) − NF[ft] |
| 7 | : stop & = mean(feature [−(idx + 1): ]) < fₜₕ [ft][idx] |
| 8 | : validactivity & = is_valid_activity(feature, T) |
| 9 | : end For |
| 10 | : if stop & validactivity then |
| 11 | : Trigger the gesture classifier |
| 12 | : end if |

In certain embodiments, block 1810 corresponds to an initialization step, at which a feature threshold variable is defined per feature within a predefined feature set. The feature set is predefined as including: “mean”; “meanl”; “pwd”; and “pwdabs.” Respectively, the feature threshold variables include: meanth, meanlth, pwdth, and pwdabsth.

In certain embodiments, block 1810 corresponds to an input step at which the early stop checker 1202 receives the following inputs: pᵢ, c, T, NF, selected_features, and wₘₐₓ. The prediction from the binary classifier is denoted as pᵢ. The accumulator status c is input from the accumulator 906. The variable T denotes the TVD extracted feature. The variable NF denotes a dictionary that stores the noise floor for different features. The variable selected_features denotes a subset of features adopted for checking the early stop conditions. The early stop conditions include both noise frames condition and valid activity condition. In the algorithm 1800, the valid activity condition and stop condition use the same set of selected features. Also, different features sets may be used for each condition. The variable wₘₐₓ denotes a maximum size of a lookback window.

Block 1810 corresponds to steps 1-3, wherein the early stop checker is triggered when the binary classifier predicts “class 1” (illustrated as pᵢ==1). At step 1, the ADM determines whether the binary classifier predicted “class 0” for frame, (illustrated as pᵢ==0). At step 2, in response to a determination that pᵢ==0, then the outcome of the determination is set at False. Step 3 ends the procedures of block 1810.

Block 1820 corresponds to step 4, which is to map the accumulator status c to lookback window size w and the feature threshold fₜₕ to use. At step 4, a variable idx is set to a value that the lesser value from among c−1 and wₘₐₓ−1.

Block 1830 corresponds to steps 5-9, wherein for each selected feature, the ADM checks whether the noise frames condition and valid activity condition are satisfied. The ADM 720 determines, based on the accumulator status c, how many frames in the current data window to lookback and also which feature thresholds to use. For example, ADM 720 determines, from a lookup table (LUT) within which the accumulator status cis mapped to a size of lookback window w, corresponding feature thresholds fₜₕ for each selected feature. The ADM 720 sets adaptive feature thresholds fₜₕ for different values of c.

Block 1840 corresponds to lines 10-12. In response to a determination that both conditions are satisfied for all the selected features, then the outcome of the algorithm 1800 is ‘gesture end detected’ and the ADM 720 triggers the GC 730.

Although FIG. 18 illustrates one example valid activity identification algorithm 1800, various changes can be made to FIG. 18. For example, various components in FIG. 18 can be combined, further subdivided, or omitted and additional components can be added according to particular needs. As a particular example, in order for the system 700 to recognize a performance of a gesture in the gesture vocabulary 800 as a valid gesture, the radar data generated from the performance of the gesture should satisfy some validity conditions including: a gesture length condition, a signal strength condition; or a distance condition. The gesture length condition is satisfied when the derived gesture length (e.g., number of frames between gesture start 1530 and gesture end 1532 of FIG. 15) is within a certain range [lₘᵢₙ, lₘₐₓ] of gesture length. The signal strength condition is satisfied when the signal strength is between [sₘᵢₙ, sₘₐₓ] The distance condition is satisfied when the location of the user during performance of the gesture is at distance (e.g., distance 412 of FIG. 4) to radar within a certain range [dₘᵢₙ, dₘₐₓ]. As an example, for gesture vocabulary 800, lₘᵢₙ=4 and lₘₐₓ=35, in the unit of frame number. The signal strength can be defined using the similar features as noise frames in terms of Mean, Meanl, PWD and PWDabs. The range requirements for object range R₀ usually depend on the gestural applications, for example, if the application requires the user to perform the gesture in the range from 10 cm to 30 cm.

There are different ways to check whether those validity conditions are satisfied. One way is for the ADM 720 to set up the thresholds and count the number of the signal frames. For example, the early stop checker 1202 can count the number of signal frames by determining whether the strength of the signal frames satisfies the signal strength threshold constraints [sₘᵢₙ, sₘₐₓ] and also whether the signal frames are captured within the desired range [dₘᵢₙ, dₘₐₓ]. If the number of signal frames counted is larger than a length threshold Lin, then the early stop checker 1202 will determine that the data window contains a valid activity and feed the data window (as gesture data 725) to the GC 730. The ADM 720 continues to machine learn the validity parameters (i.e., l_min, l_max, s_min, s_max, d_min, d_max) of the rules from the data. In certain embodiments, the ADM 720 identifies the 10 strongest frames for each sample due to the fact that the shortest gesture (e.g., swipe gesture 810 or 812) has a length threshold Lin of only 4 frames. Based on the observations and experiments according to this disclosure, the data window has more than 3 frames with features that are larger than certain thresholds. The feature threshold (e.g., MDSF) can be selected from ranged that is 0.01% to 0.1% of the 3rd strongest frame.

In certain embodiments of this disclosure, the early stop checker 1202 can set up a minimum counting threshold that requires at least k noise frames at the gesture end. This minimum counting threshold tradeoffs (e.g., to balance) the accuracy of the binary classifier 904 and adds some flexibility for performing the gestures in the gesture vocabulary 800, especially for a gesture which may have some pauses in between, like the pinch gesture 806 or 808. This minimum counting threshold could be set at the maximum allowable duration for the pause of a valid gesture. For example, if the pause is allowed to endure up to 3 frames, then the minimum counting threshold k could be set at least 3.

In certain embodiments of this disclosure, when the valid activity checker 1320 of FIG. 13 is executed, the early stop checker 1202 also adds more rules to reject non-gesture samples based on range, velocity, angle, length, and etc. That is, the early stop checker 1202 applies constraints regarding the range, velocity, angle variation of a valid gesture. The early stop checker 1202 can check each condition individually or combine some of conditions together. For example, if the gesture vocabulary 800 includes all micro-gestures, the micro-gestures have limited range variation across the gesture. If large range variation (e.g., greater than the range variation limit) is detected inside a data window, then the data window has a low probability of representing or does not include a valid gesture. Further, if an activity with short length is detected inside the data window, then it is highly possible that the activity is a swipe motion. The early stop checker 1202 expects as swipe motion to have a large variation in angle. The any of these conditions can be combined to set up proper gating to rule out more non-gesture samples and to reduce false alarms.

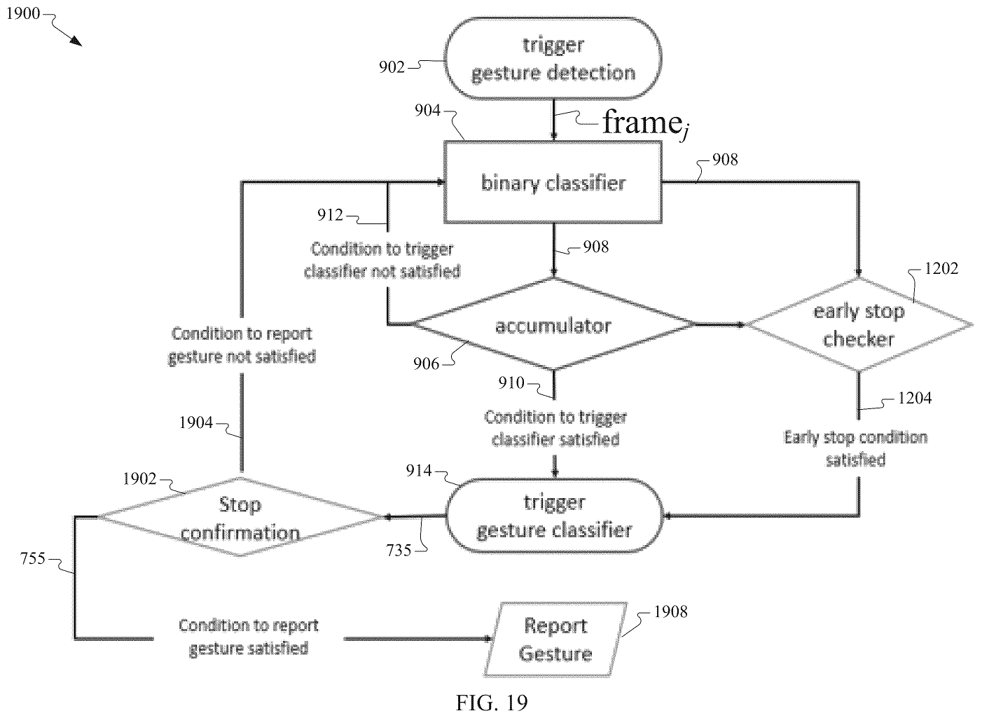

FIG. 19 illustrates an end-detection method 1900 with a stop confirmation 1902 in accordance with an embodiment of this disclosure. The stop confirmation 1902 (also referred to as block 1902) includes functions of the SCM 750 of FIG. 7. The block 902, binary classifier 904, accumulator 906, block 914, early stop checker 1202 of FIG. 19 can be the same as described above with FIGS. 9 and 12. The embodiment of the method 1900 shown in FIG. 19 is for illustration only, and other embodiments can be used without departing from the scope of this disclosure.

The method 1900 is executed by the second embodiment of the end-to-end gesture recognition system 700 of FIG. 7 and utilizes the GC 730 to jointly determine (together with the ADM720) the end of a gesture. The SCM 750 can call the GC 730 more than once and use the output 735 of GC to update some stop confirmation conditions to be gesture-based conditions, and also add some new rules to avoid early detection, avoid a false alarm, and reduce the latency of the processing pipeline of the system 700. The rationale of calling the GC 730 more than once is to use a tentative prediction from GC to help to determine the end of the gesture earlier and more accurately.

To avoid duplicative descriptions, this disclosure describes components of the method 1900 of FIG. 19 that are different from method 1200 of FIG. 12. Particularly, the output 735 from the GC 730 is illustrated as an arrow from block 914 to the stop confirmation 1902. That is, in response to the ADM triggering the GC 730 at block 914, the GC 730 operates to predict the gesture type and generate the output 735.

As introduced above, output 735 from the GC 730 includes a prediction confidence value of the GC, a predicted gesture type, a derived gesture length, and so forth. As prediction confidence values of the GC, the output 735 can include six probabilities ( [symbol] through [symbol] ) corresponding to the six gestures in the gesture vocabulary 800 (FIG. 8), respectively. For example, a first probability [symbol] represents the likelihood that the user performed a radial circle gesture 802, and the fourth probability [symbol] represents the likelihood that the user performed a double pinch gesture 808. From among the six probabilities ( [symbol] through [symbol] ) corresponding to the six gestures, the probability that has the greatest value indicates the predicted gesture type within the output 735. For example, the GC 730 determines that the user performed a double pinch gesture 808, by determining that the fourth probability [symbol] has the greatest value from among the six probabilities.

The stop confirmation 1902 is illustrated as a first decision block and represents the SCM 750 downstream from the GC 730. The stop confirmation 1902 at this first decision block includes the function to determine, based on the output 735 (e.g., the prediction confidence value of the GC, the predicted gesture type, derived gesture length, etc.) of the gesture classifier, whether to report the gesture to a gestural application or to defer reporting the gesture to the gestural application. In response to a determination that a stop confirmation condition is satisfied, the SCM 750 determines to report the gesture to a gestural application, but if the stop confirmation condition is not satisfied, then SCM 750 determines to not report the gesture. An indicator 1904 that the stop confirmation condition is not satisfied is illustrated as an arrow from block 1902 to the binary classifier 904. Alternatively, an indicator 755 that the stop confirmation condition is satisfied is illustrated as an arrow from block 1902 to block 1908.

At block 1908, the system 700 outputs an event indicator 780 indicating that a user of the electronic device performed the predicted gesture type, which is both classified by the GC 730 and confirmed by the SCM 750. For example, the event indicator 780 can be the indicator 755 (including the output 735 from the GC 730) output by the SCM 750.

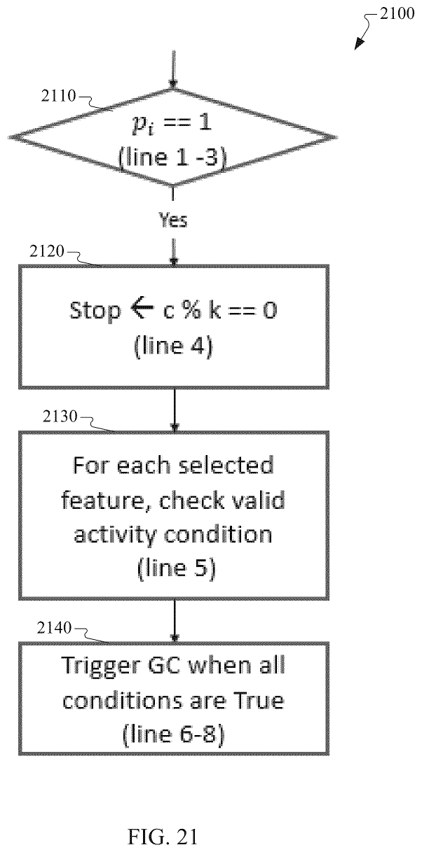

In certain embodiments, the ADM 720 can receive indicator 1904 from the SCM 750. In response to receiving the indicator 1904, the ADM 720 continues checking the incoming frames, received into the binary classifier 904, and the early stop checker 724 can add additional frames into the data window within the gesture data 725. That is, SCM 750 output the indicator 1904 to control the ADM 720 to update the gesture data 725 and to control (e.g., call) the GC 730 to analyze the updated gesture data 725 to generate an updated prediction of gesture type. The SCM 750 uses the predicted gesture type to update conditions in the early stop checker 1202 to be gestured-based, as described further below at FIG. 21.

In a non-limiting scenario, the stop confirmation condition is combination of multiple gesture-based conditions, and this stop confirmation condition is not satisfied if both the derived gesture length is less than a certain threshold (e.g., lₘᵢₙ) is true and any of the following is true: the prediction confidence value of the GC is low (e.g., less than a certain threshold) or the predicted gesture type belongs to a set of gestures (e.g., G2M set) that have some pause in-between the motion. Otherwise, the stop confirmation condition is satisfied, and the method 1900 proceeds to block 1908 to report the predicted gesture type immediately.

Each gesture in the gesture vocabulary 800 has its own signatures (e.g., expectations of gesture length, pause/no-pause, range variation, variation in angle, etc.). The SCM 750 can apply particular rules in relation to the different gesture types. In a first example of signatures, each gesture has its own range for gesture length, and SCM 750 divides the gestures of the gesture vocabulary 800 by their length. If the derived gesture length within the output 735 is too short for the predicted gesture type, then the stop confirmation condition is not satisfied (1904), and the method 1900 returns to the binary classifier 904 to keep checking the incoming frames before reporting the gesture.

In the second example, the signature of some of the gestures has energy dropping in the middle (in-between energy representing motion), which can be a pause in-between motion. The signature of the pinch gesture 806, 808 includes a pause. So, the binary classifier prediction 908 might mistakenly declare energy dropping in the middle as an end of the gesture instead of as the middle of the gesture. To avoid this false alarm, the SCM 750 provides a waiting window, which could be the maximal pause allowed to be performed within the gesture. At block 1902, the stop confirmation condition is satisfied (755) if a user actually performs a pinch gesture that includes a pause that lasts a shorter time than the waiting window.

In the third example of signatures, if the gesture vocabulary 800 contains both a gesture that is a ‘single’ version and a ‘double’ or ‘multiple’ version, such the single pinch gesture 806 and double pinch gesture 808, then the SCM 750 provides a waiting window to confirm whether the performance by the user is or is not the multiple version of the gesture. The waiting window could be set based on the maximal allowable pause to perform the multiple version. If the output 735 indicates that a single pinch gesture 806 is detected, then to confirm that a double pinch gesture is not the gesture that the user is currently performing, the stop confirmation 1902 waits for the waiting window to elapse before determining whether stop confirmation condition is satisfied.

In the fourth example of signatures, pause-free gestures (e.g., G2S set 762) are less likely to have pause in the middle. Particularly, it is likely that the circle gesture 802 and 804 and the swipe gesture 810 and 812 do not have a pause in the middle. Accordingly, when the output 735 indicates a pause-free gesture, the stop confirmation 1902 can be more confident about the prediction 908 of binary classifier 904 for those cases and proceed to block 1908 to report the gesture earlier. That is, if the predicted gesture type is one of the pause-free gestures, then the stop confirmation condition can be satisfied based on the prediction confidence value of the GC exceeding a lower confidence threshold. However, if the predicted gesture type is not one of the pause-free gestures, then the stop confirmation condition can be satisfied based on for the prediction confidence value of the GC exceeding a higher confidence threshold.

Although FIG. 19 illustrates one example end-detection method 1900 with a stop confirmation 1902, various changes can be made to FIG. 19. For example, various components in FIG. 19 can be combined, further subdivided, or omitted and additional components can be added according to particular needs.

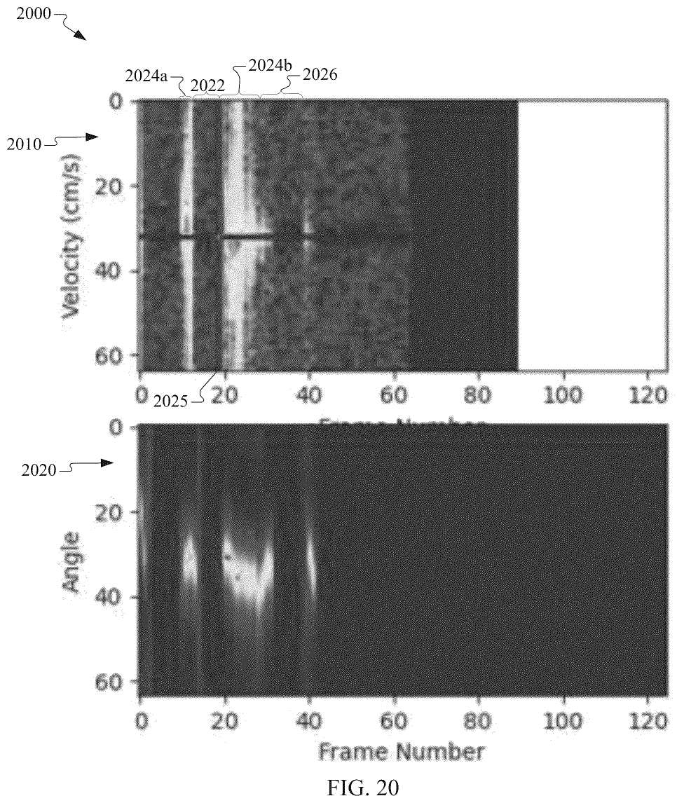

FIG. 20 illustrates extracted features 2000 including TVD 2010 and TAD 2020 for the same period of time during which a user performed a single pinch gesture 806 that includes a pause duration 2022 according to embodiments of this disclosure. The embodiment of the extracted features 2000 shown in FIG. 20 is for illustration only, and other embodiments can be used without departing from the scope of this disclosure.

The pause duration 2022 occurs in-between signal frames 2024a and 2024b that represent motion single pinch gesture 806. The pause duration 2022 may cause the early stop checker 1202 to determine that the first signal frames 2024a represent a gesture and to output an indicator 2025 (such as early stop indicator 1204) that frame₁₉ is the end of the gesture (e.g., a close only gesture that starts from the separated thumb and index fingers and includes movement of touching them). If the first signal frames 2024a and the pause duration 2022 are provided to the GC 730 as gesture data 725, then the GC 730 generates an initial output 735 that is analyzed at the stop confirmation 1902 of FIG. 19. The SCM 750 determines the stop confirmation condition is not satisfied (1904), and the binary classifier 904 continues checking the incoming frames before reporting the gesture. For example, the SCM 750 can determine that the stop confirmation condition is not satisfied if the initial output 735 includes a predicted gesture type, but also includes a prediction confidence value that is too low for the predicted gesture type or a derived gesture length that is too short for the predicted gesture type.

The second signal frames 2024b represent the motion of an open only gesture that starts from thumb and index fingers touching and includes movement of separating them. Following the second signal frames 2024b are a portion 2026 of frames within the extracted features 2000. Similar to the clear end 1402 of FIG. 14, a portion 2026 of frames also exhibits an energy dropping pattern with a multiple noise frames toward the end. The portion 2026 of frames may cause the ADM 720 to determine that frame₄₀ is the end of the single pinch gesture 806, by using the accumulator 906 or the early stop checker 1202 to trigger the GC 730 again.

If the first signal frames 2024a, the pause duration 2022, the second signal frames 2024b, and the portion 2026 of frames are provided together as gesture data 725 to the GC 730, then the GC 730 generates a subsequent output 735 that causes the SCM 750 to determine that the stop confirmation condition is satisfied. For example, the SCM 750 can determine that the stop confirmation condition is satisfied if the subsequent output 735 includes a prediction confidence value greater than a confidence threshold corresponding to the single pinch gesture 806 or a derived gesture length within a range for gesture length corresponding to the single pinch gesture 806. The SCM 750 enables an event indicator 780 to be output indicating that a user of the electronic device performed the single pinch gesture 806.

FIG. 21 illustrates a simplified early stop checker algorithm (“Algorithm 3”) 2100 implemented as part of the early stop checker 1202 of the end-detection method 1900 of FIG. 19 in accordance with an embodiment of this disclosure. The embodiment of the algorithm 2100 shown in FIG. 21 is for illustration only, and other embodiments can be used without departing from the scope of this disclosure.

The simplified early stop checker algorithm 2100 is shown as both a series of steps in Table 4 and as a series of flowchart blocks in FIG. 21. Each of the flowchart blocks in FIG. 21 corresponds to a subset of the steps in Table 4.

TABLE 4
Algorithm 3: Simplified Early Stop Checker Algorithm

| Initialization | : stop ← True, validactivity ← True |
|---|---|
| Input | : pᵢ, c, T, NF, selected_features, k |
| 1 | : if pᵢ = = 0: then |
| 2 | : return False |
| 3 | : end if |
| 4 | : stop ← c % k == 0 |
| 5 | : validactivity ← |
| | is_valid_activity(T, NF, selected_features) |
| 6 | : if stop & validactivity then |
| 7 | : Trigger the gesture classifier |
| 8 | : end if |

One of the reasons to have early stop checker 1202 is to reduce the number of times to trigger gesture classifier to limit the increase in the computational complexity. The early stop checker 1202 can be simplified according to this pipeline. One way to simplify the early stop checker 1202 is shown in Algorithm 3, wherein the GC 730 is not triggered every time c is updated, but instead when c % k==0. For example, if k==2, then the early stop checker 1202 triggers the GC 730 when c is an even number (i.e., when c is a multiple of k) and valid activity is detected in the data window. In this embodiment, the accumulator 906 applies a fixed accumulation duration, which can be used as an upper bound for the gesture detection.

The initialization step and input step can occur at block 2110, in certain embodiments. At the input step, the early stop checker 1202 receives the following inputs: pᵢ, c, T, NF, selected_features, and k. The variable k denotes a multiplier for controlling periodicity of triggering the GC. Block 2110 corresponds to steps 1-3, wherein the procedure is similar to the procedure at block 1810 of FIG. 18.

Block 2120 corresponds to step 4, where the early stop checker is set to stop if the accumulator status c is equal to a multiple (e.g., integer multiple) of the multiplier k. To stop includes to not perform the procedures at blocks 1310 and 1320 of FIG. 13, but instead to return from block 2120 to the binary classifier 904. Block 2130 corresponds to step 5, wherein for each selected feature, the ADM determines whether the valid activity condition is satisfied. Block 2140 corresponds to steps 6-8. In response to a determination that the valid activity conditions are satisfied for all the selected features, then the ADM 720 triggers the GC 730.

Although FIG. 21 illustrates one example early stop checker algorithm 2100, various changes can be made to FIG. 21. For example, various components in FIG. 21 can be combined, further subdivided, or omitted and additional components can be added according to particular needs. As a particular example, the ADM 720 continues to analyze incoming frames, even after triggering the GC 730 and after the output 735 provides a predicted gesture type to the SCM 750.

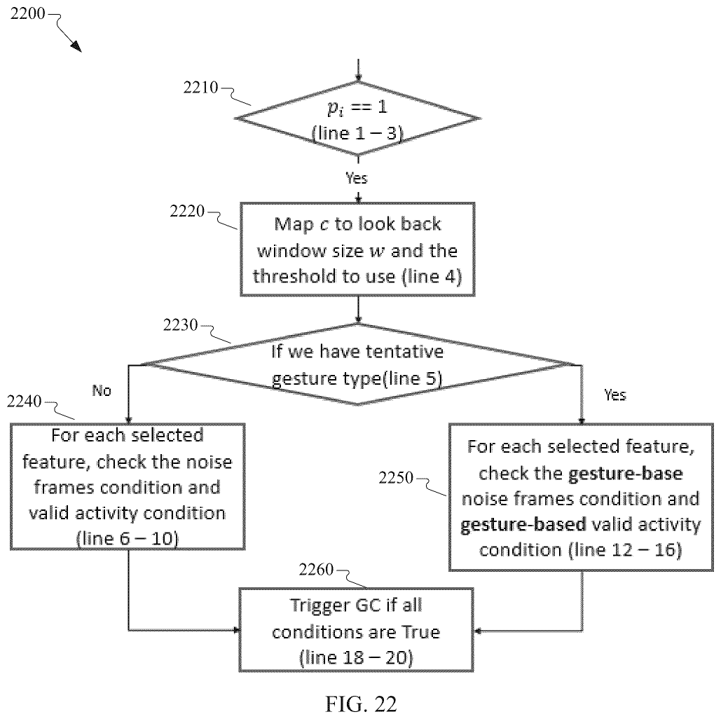

FIG. 22 illustrates a gesture-based early stop checker algorithm (“Algorithm 4”) 2200 implemented as part of the early stop checker 1202 of the end-detection method 1900 of FIG. 19 in accordance with an embodiment of this disclosure. The embodiment of the algorithm 2200 shown in FIG. 22 is for illustration only, and other embodiments can be used without departing from the scope of this disclosure.

Algorithm 2200 is another way is to loosen the early stop conditions, for example, to set the feature threshold with a larger MDSF and also once a tentative gesture type g is predicted by the GC 730, the ADM uses the feature thresholds with MDSF of that tentative gesture type g. The rationale to set different thresholds for different gesture types is that experiments of this disclosure demonstrated that different gestures have different signal strengths. For example, a circle gesture usually has stronger signal strength than the other gestures.

The gesture-based early stop checker algorithm 2200 is shown as both a series of steps in Table 5 and as a series of flowchart blocks in FIG. 22. Each of the flowchart blocks in FIG. 22 corresponds to a subset of the steps in Table 5.

TABLE 5
Algorithm 4: Gesture-based Early Stop Checker Algorithm

| Initialization | : stop ← True, validactivity ← True, fₜₕ ← {“mean”: |
|---|---|
| | meanth, “meanl”: meanlth, “pwd”: pwdth, “pwdabs”: |
| | pwdabsth}, ges_fₜₕ |
| Input | : pᵢ, c, T, NF, selected_features, g, wₘₐₓ |
| 1 | : if pᵢ = = 0: then |
| 2 | : return False |
| 3 | : end if |
| 4 | : idx = min(c − 1, wₘₐₓ − 1) |
| 5 | : if g is None: then |
| 6 | : For f in selected_features: |
| 7 | : feature = calculate_feature(f, T) − NF[f] |
| 8 | : stop & = mean(feature[−(idx + 1): ]) < |
| | fₜₕ[f][idx] |
| 9 | : validactivity & = is_valid_activity(feature, T) |
| 10 | : end For |
| 11 | : else: |
| 12 | : For f in selected_features: |
| 13 | : feature = calculate_feature(f, T) − NF[f] |
| 14 | : stop & = mean(feature[−(idx + 1): ]) < |
| | ges_fₜₕ [g][f][idx] |
| 15 | : validactivity & = −is_valid_activity(feature, |
| | T, g) |
| 16 | : end For |
| 17 | end if |
| 18 | : if stop & validactivity then |
| 19 | : Trigger the gesture classifier |
| 20 | : end if |

The initialization step and input step can occur at block 2210, in certain embodiments. At the input step, the early stop checker 1202 receives the following inputs: pᵢ, c, T, NF, selected_features, g, and wₘₐₓ. The variable g denotes the predicted gesture type within the most recent output 735 from the GC 730. That is, the tentative gesture type is not limited being within an initial output from the GC, and the predicted gesture type contained within a subsequent output from the GC updates (e.g., replaces) the previous (e.g., initial) tentative gesture type. Block 2210 corresponds to steps 1-3, wherein the procedure is similar to the procedure at block 1810 of FIG. 18. Block 2220 corresponds to step 4, wherein the procedure is similar to the procedure at block 1820 of FIG. 18.

Block 2230 corresponds to step 5, where the early stop checker 1202 determines whether the GC 730 has generated an output 735. If the GC 730 has not yet provided an initial output 735, then the algorithm 2200 proceeds to block 2240, but if the GC has provided an output 735, then the algorithm 2200 proceeds to block 2250.

The predicted gesture type within the initial output 735 is referred to as a tentative gesture type, especially if the initial output 735 from the GC 730 does not satisfy the stop confirmation condition. In other words, the variable g denotes the predicted/tentative gesture type.

To reconfigure the early stop checker 1202, the SCM 750 updates the early stop conditions based on this tentative gesture type. The validity conditions (i.e., applied by the valid activity checker 1320 of FIG. 13) are examples of early stop conditions that are updated to correlate to the tentative gesture type and that are defined by any of the following: (i) gesture-based range for gesture length; (ii) gesture-based range for signal strength; (iii) gesture-based range variation; and (iv) gesture-based angle variation.

Block 2240 corresponds to steps 6-10, wherein if the GC 730 has not yet provided a tentative gesture type via an initial output 735, then the valid activity condition is general, meaning not yet updated and not gesture-based. For each selected feature, the early stop checker 1202 determines whether general (i.e., not gesture-based) versions of the noise frames condition and valid activity condition are satisfied.

On the other hand, block 2250 corresponds to steps 12-16, wherein if the GC 730 has provided a tentative gesture type via an initial output 735, then the valid activity condition is updated to be gesture-based, as shown at block 2250. For each selected feature, the early stop checker 1202 determines whether the gesture-based noise frames condition and gesture-based valid activity condition are satisfied. Block 2260 corresponds to steps 18-20, where in response to a determination that the early stop conditions are satisfied for all the selected features, then the ADM 720 triggers the GC 730.

Although FIG. 22 illustrates one example algorithm 2200, various changes can be made to FIG. 22. For example, various components in FIG. 22 can be combined, further subdivided, or omitted and additional components can be added according to particular needs. As a particular example, the tentative gesture type is not limited to being within an initial output from the GC, and the predicted gesture type contained within a subsequent output from the GC updates (e.g., replaces) the previous (e.g., initial) tentative gesture type.

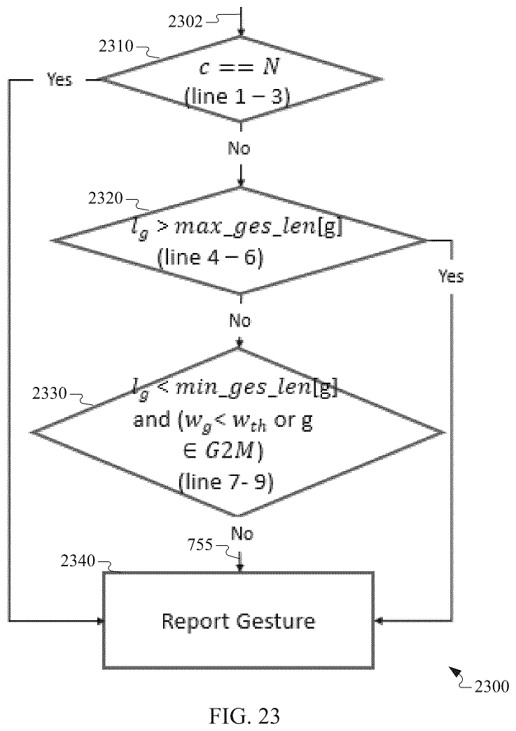

FIG. 23 illustrates a stop confirmation algorithm (“Algorithm 5”) 2300 implemented as part of the stop confirmation 1902 of the end-detection method 1900 of FIG. 19 in accordance with an embodiment of this disclosure. The embodiment of the algorithm 2300 shown in FIG. 23 is for illustration only, and other embodiments can be used without departing from the scope of this disclosure.

The stop confirmation algorithm 2300 is shown as both a series of steps in Table 6 and as a series of flowchart blocks in FIG. 23. Each of the flowchart blocks in FIG. 23 corresponds to a subset of the steps in Table 6.

TABLE 6
Algorithm 5: Stop Confirmation Algorithm

| Initialization | : report ← True, min_ges_len, max_ges_len, wₜₕ, G |
|---|---|
| Input: | : c, g, w_{g}, l_{g} |
| 1 | : if c = = N: then |
| 2 | : return report ← True |
| 3 | : end if |
| 4 | : if l_{g} > max_ges_len[g]: then |
| 5 | : return report ← True |
| 6 | : end if |
| 7 | : if l_{g} < min_ges_len[g] and (w_{g} < wₜₕ or g ∈ G2M): then |
| 8 | : report ← False |
| 9 | : end if |

The SCM 750 is triggered after gesture classification is performed by the GC 730. The input 2302 of the SCM 750, includes accumulator status c, the prediction confidence w_{g} of GC, the predicted gesture type g, and the derived gesture length l_{g}.

At block 2310, the ADM 720 determines whether the accumulator status c is equal to N. If it is true that c==N, then the SCM 750 determines to report the gesture g, and the algorithm 2300 proceeds to block 2340. This accumulation condition (c==N) is used to set up the upbound of the latency.

At block 2320, to determine whether the derived gesture length l_{g} is too long for the tentative gesture type, the SCM 750 determines whether l_{g} is outside a range defined by max_ges_len[g]. For example, the range of gesture length specifically for the predicted gesture type g can be defined as greater than min_ges_len[g] and less than max_ges_len[g]. For example, lₘᵢₙ=min_ges_len[g] and lₘₐₓ=max_ges_len[g]. If the stop confirmation condition (l_{g}>max_ges_len[g]) is true, then the SCM 750 determines to report the gesture g, and the algorithm 2300 proceeds to block 2340.

Then at block 2330, the SCM 750 checks other stop confirmation conditions to determine whether to report the gesture or defer the decision. That is, there are other ways to set up the stop confirmation conditions for SCM 750. In this example, the stop confirmation conditions include gesture-based stop confirmation conditions defined by the gesture length, confidence value of the prediction (w_{g}<wₜₕ), and also the gesture requirements for different gesture types (g∈G2M). For example, if the SCM 750 determines that derived gesture length l_{g} is too short for the tentative gesture type (i.e.,) and thus outside a range defined by min_ges_len[g], then the SCM 750 outputs the indicator 1904, indicating a determination to defer the decision. However, if the gesture-based stop confirmation condition (i.e., ((w_{g}<wₜₕ or g∈G2M) and l_{g}<min_ges_len[g]) is FALSE) is satisfied, then the SCM 750 outputs the indicator 755, and the algorithm 2300 proceeds to block 2340. The procedure at block 2340 is the same as or similar to the procedure at block 1908 of FIG. 19.

### Gesture-Based Latency Reduction—Waiting Window

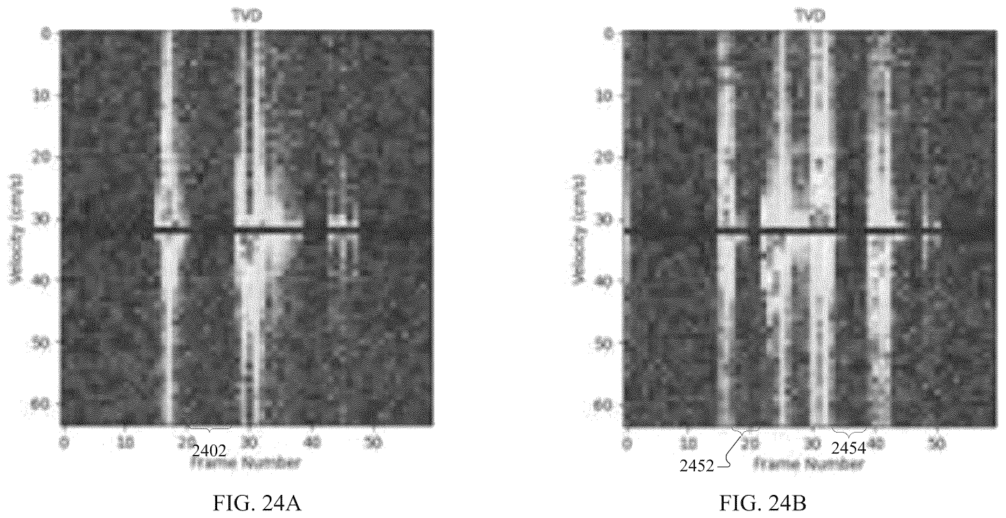

FIGS. 24A and 24B illustrate two TVDs 2400 and 2450 that together represent a set of gestures that have one or more pauses in the middle of the gesture, in accordance with an embodiment of this disclosure. The variable G (capital letter) denotes a set of gestures, such as the entire gesture vocabulary 800 of FIG. 8. From among G, a subset of gestures require extra monitoring (e.g., waiting window) in order to confirm that the gesture has ended, and this subset of gestures is referred to as G2M. The SCM 750 executes the G2M module 770 of FIG. 7 to determine whether the tentative gesture type belongs to G2M, and to trigger a waiting window in response to a determination that the tentative gesture type belongs to G2M. From among G2M, a subset gestures that include one or more pauses in-between motion of the gesture is referred to as G2MS, namely the G2MS set 774 of FIG. 7. For example, the TVDs 2400 and 2450 represent the G2MS set 782 of FIG. 7. If the tentative gesture type includes one or more pauses in-between motion of the gesture, then as introduced above, the waiting window is a technical solution to prevent a premature detection of an end of the gesture before the user complete performance of the gesture. FIG. 24A illustrates a TVD 2400 of a single pinch gesture 806 that includes one pause duration 2402, in accordance with an embodiment of this disclosure. FIG. 24B illustrates a TVD 2450 of a double pinch gesture 808 that includes multiple pause durations 2452 and 2454, in accordance with an embodiment of this disclosure. The TVDs 2400 and 2450 include similar components as the TVD 2010 of FIG. 20, such as signal frames before and after the pause duration 2402, 2452, 2454 and a portion of frames containing an energy dropping pattern. The embodiment of the TVDs 2400 and 2450 representing the G2MS shown in FIGS. 24A-24B is for illustration only, and other embodiments can be used without departing from the scope of this disclosure.

FIG. 25 illustrates an end-detection method 2500 for gestures requiring extra monitoring (G2M) in accordance with an embodiment of this disclosure. The block 902, binary classifier 904, accumulator 906, block 914, early stop checker 1202, and stop confirmation 1902 of FIG. 25 can be the same as described above with FIG. 19. The embodiment of the method 2500 shown in FIG. 25 is for illustration only, and other embodiments can be used without departing from the scope of this disclosure.

The method 2500 is executed by the third embodiment of the end-to-end gesture recognition system 700 of FIG. 7 and utilizes the G2M module 770 to determine whether to report a gesture. To avoid duplicative descriptions, this disclosure describes components of the method 2500 of FIG. 25 that are different from method 1900 of FIG. 19. Particularly, blocks 2502 and 2504 within the method 2500 includes functions executed by the G2M module 770 of FIG. 7.

At block 2502, the G2M module 770 is triggered by receiving the indicator 755 from the SCM 750, which has determined to report the gesture. For example, the indicator 755 indicates that the SCM 750 has determined that gesture-based stop confirmation conditions, such as those defined by the gesture length (lₘᵢₙ<l_{g}<lₘₐₓ) and confidence value of the prediction (w_{g}<wₜₕ), are satisfied. In response to being triggered, the G2M module determines whether the tentative gesture type belongs to the G2M set of gestures. The G2M set includes a subset referred to as the G2MR set 772, which is composed of repeat-motion gestures, such as a gesture that is a ‘double’ or ‘multiple’ version, such as the double pinch gesture 808. Also, a G2MS set 774 is a subset of the G2M set and includes each gesture with a pause in-between motion, such as both the single and double pinch gestures 806 and 808. In certain embodiments, to determine whether the tentative gesture type belongs to the G2M set, the G2M module 770 determines whether the tentative gesture type belongs to the G2MR set 772 and determines whether the tentative gesture type belongs to the G2MS set 774. In response to a determination that the G2M set includes the tentative gesture type (i.e., g E G2M) and that the G2M module 770 has not yet waited for a waiting period, the method 2500 proceeds to block 2504. Alternatively, if a waiting period has already been setup, and the G2M set includes the tentative gesture type, and the waiting period has expired, then the method 2500 proceeds to block 2508. As another alternative, in response to a determination that the G2M set does not include the tentative gesture type, the method 2500 proceeds to block 2508 to report the gesture to a gestural application. The procedure at block 2808 is the same as or similar to the procedure at block 1908 of FIG. 19. For example, at block 2508, the event indicator 780 can be output by the G2M module 770 and can include contents of the indicator 755 (including the output 735 from the GC 730).

At block 2504, the G2M module 770 sets up a waiting window. As a practical matter, the derived gesture length preceding a pause or energy dropping pattern is usually much shorter than the normal case (e.g., gesture length of a complete gesture). So, the method 2500 of FIG. 25 enables the system 700 to continue monitoring incoming frames (frame) of the gesture until the condition to report the gesture is satisfied. However, when the derived gesture length is long enough, the perturbation or shaking of the user's finger after the gesture end will not hinder the method 2500 to report the gesture end. There are two types of gestures in the G2M set. One case is that the gesture vocabulary 800 may include single and double (or even X-time repetitions with X>2) versions of a gesture. For example, the gesture vocabulary 800 may include both single pinch gesture and double pinch gesture. In this case, once the GC 730 detects single pinch, block 2502 enables double checking that the performance of the gesture is not a double pinch kind of gesture belonging to the G2MR set 772. The other case is that some of the gestures may have pause in-between the motion, in which case, the method 2500 enables waiting for a certain time until the end of the gesture end is real for this kind of belonging to the G2MP set 774.

In certain embodiments of block 2504, waiting window rules for the G2MR set 772 are different than waiting window rules for the G2MP set 774. The waiting window is set to the maximum allowed pause when performing a gesture belongs to G2MR set 772 and the maximum allowed pause for performing a gesture in G2MP set 774, respectively.

Once the waiting window is triggered (e.g., setup), the G2M module 770 updates the early stop checker 1202, as illustrated by the arrow from block 2504 to 1202. The early stop checker 1202 will add one more condition, such as a waiting window condition that is satisfied by expiry of the triggered waiting period, to determine whether or not trigger a gesture classifier for the upcoming frames. If all the conditions of early stop checker 1202 are satisfied again, then GC 730 will be triggered again by the early stop checker 1202. If GC 730 still predicts g, then the G2M module 770 will report the gesture and remove the waiting window condition from early stop checker. If GC 730 predicts a different gesture type g′ than g, then G2M module 770 will remove the previous waiting window condition, and initialize a new wait window condition for the new gesture type if the G2M set includes the different gesture type g′ (i.e., g′∈G2M).

FIG. 26 illustrates an end-detection method 2600 for gestures requiring shortened monitoring (G2S) in accordance with an embodiment of this disclosure. The block 902, binary classifier 904, accumulator 906, block 914, early stop checker 1202, and stop confirmation 1902 of FIG. 26 can be the same as described above with FIG. 19. The embodiment of the method 2600 shown in FIG. 26 is for illustration only, and other embodiments can be used without departing from the scope of this disclosure.

The method 2600 is executed by the third embodiment of the end-to-end gesture recognition system 700 of FIG. 7 and utilizes the G2S module 760 to determine whether to report a gesture. To avoid duplicative descriptions, this disclosure describes components of the method 2600 of FIG. 26 that are different from method 1900 of FIG. 19. Particularly, block 2602 within the method 2600 includes functions executed by the G2S module 760 of FIG. 7.

At block 2602, in response to being triggered by receiving the output 735 from the GC 730, the G2S module 760 determines whether the tentative gesture type belongs to a G2S set of pause-free gestures, which is a subset of from among the gesture vocabulary 800 (G), that are not allowed to have any pause in the middle. In response to a determination that the G2S set does not include the predicted gesture type g, the method 2600 proceeds to block 1902, where the SCM 750 is triggered to determine whether to report the gesture.

At block 2608, in response to a determination that the predicted gesture type belongs to a G2S set 762 (g∈G2S) and the derived gesture length is in a specified range, the G2S module 760 determines to report the gesture. Particularly, the event indicator 780 can be output by the G2S module 760 and can include contents of the output 735 from the GC 730 to the G2S module 760. As a technical solution to effectively reduce latency for gestures belonging to G2S set 762, the G2S module 760 enables the reporting of the predicted gesture type to occur at the end of the signal frames even if the radar data includes some finger perturbation, hand shaking or other noise after the gesture end, for example, as shown by the gesture end 1532 of the signal frames 1540 of FIG. 15. In scenarios in which the SCM 750 generates the indicator 755, the procedure at block 2608 can be the same as or similar to the procedure at block 1908 of FIG. 19.

Although FIG. 26 illustrates one example end-detection method 2600 for G2S, various changes can be made to FIG. 26. For example, various components in FIG. 26 can be combined, further subdivided, or omitted and additional components can be added according to particular needs.

FIG. 27 illustrates a table of performance of the system with the latency reduction features according to embodiments of this disclosure (labeled as “With Early Stop Checker”), compared to performance of a gesture recognition system without the latency reduction features of this disclosure (labeled as “Without Early Stop Checker”). The columns represent a number N of frames within the data window, for example, N=4 through N=11.

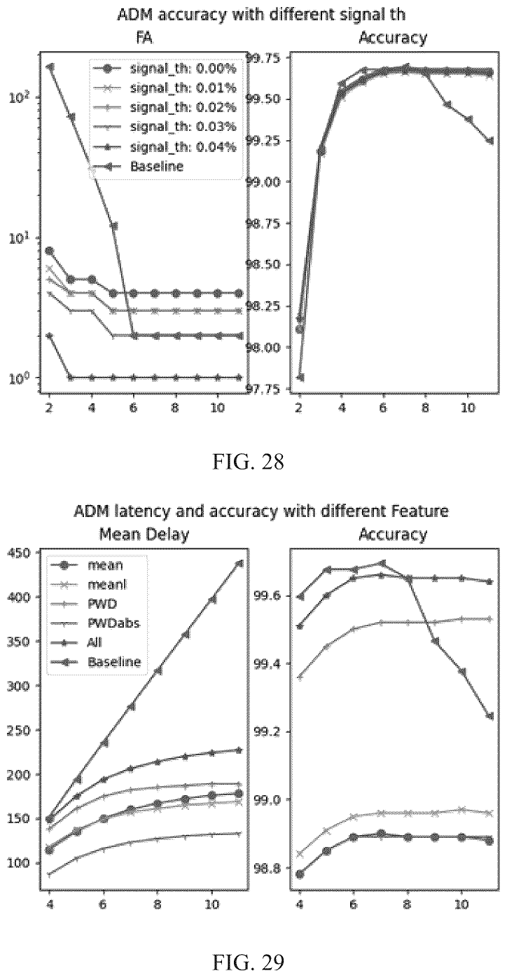

The experiment is done on a dataset with 19 users and 11400 gestures samples. Each user has 600 gesture samples, where 100 samples per gesture. The first two rows of the table of FIG. 27 indicate a first metric, namely, a number of false alarms (FA) detected. The signal condition in early stop checker works effectively to remove false alarm cases. Only one false alarm case is remaining after applying the valid activity checker 1320 of FIG. 13, and this one false alarm case is also demonstrated in FIG. 28. The second two rows of the table of FIG. 27 indicate a second metric, accuracy compared to a real end of performance of a gesture. There are three kinds of failure cases including early detection (e.g., ADM detects gesture end at the middle of the gesture), misdetection (e.g., ADM does not detect an end of the gesture), and late detection (e.g., ADM detects the end more than 20 frames after the real end). The third and fourth rows of the table of FIG. 27 indicate the mean delay and also 90% delay, respectively, to demonstrate measurements of the latency performance. When N=11, embodiments of this disclosure reduce latency by 57.66% (from 437 ms to 185 ms) and improved 0.42% accuracy.

FIG. 28 illustrates false alarms of the valid activity checker with different signal thresholds in accordance with an embodiment of this disclosure. Particularly, FIG. 28 shows the false alarms performance metric and corresponding ADM accuracy with different signal thresholds, and evaluates of the valid activity checker 1303 with the different signal thresholds.

FIG. 29 illustrates ADM latency and accuracy with different features, in accordance with an embodiment of this disclosure. Particularly, FIG. 29 illustrates that experiments according to this disclosure evaluated the performance of using one single extracted feature of the 4 features introduced above to set up the thresholds. The experiment shows that using 4 extracted features together has higher accuracy than using a single feature. However, using 4 features together also lead to longer latency than using single feature. Among the 4 features, PWD provides the best accuracy but also the longest latency. Mean and PWDabs have similar accuracy. PWDabs has less latency than Mean. Meanl has higher accuracy and also less latency than Mean. A designer of the gesture recognition system may choose the subset of features based on application requirements.

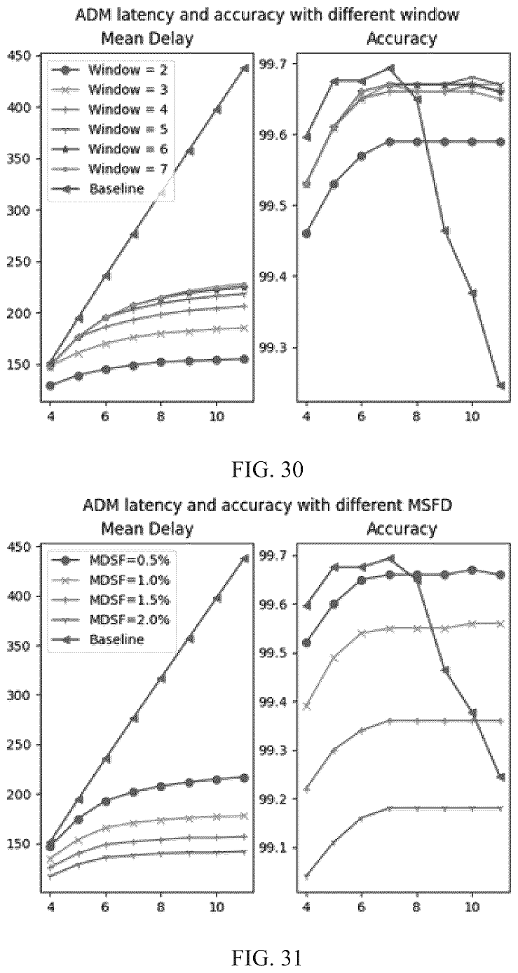

FIG. 30 illustrates ADM latency and accuracy with different look back window, in accordance with an embodiment of this disclosure. Particularly, FIG. 30 shows further reductions to latency can be achieved by adjusting the look back window. Embodiments of this disclosure can further reduce latency without affection to the accuracy, or reduce about more latency with small (<0.1%) accuracy loss.

FIG. 31 illustrates ADM latency and accuracy by set up different threshold, in accordance with an embodiment of this disclosure. Particularly, FIG. 31 shows using higher threshold to reduce latency, but which may cause more accuracy.

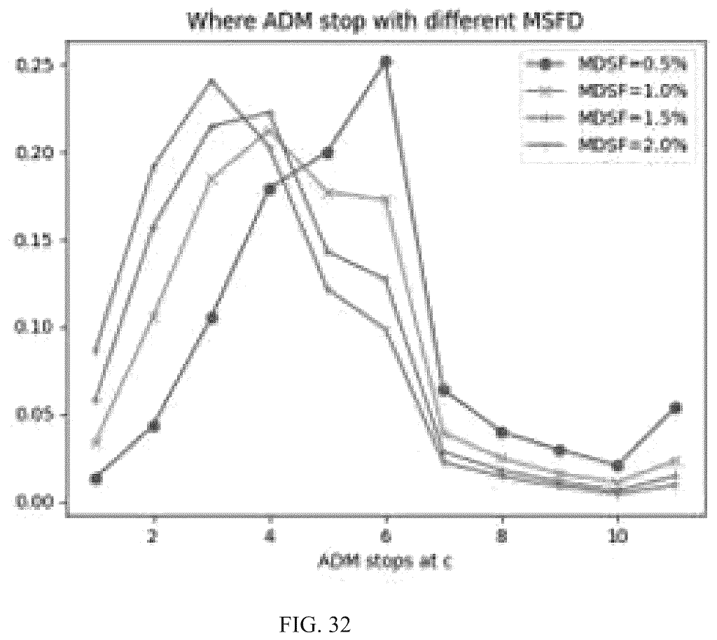

FIG. 32 illustrates percentage of data samples stops for different accumulator status values, in accordance with an embodiment of this disclosure. Particularly, FIG. 32 shows results of the effectiveness of the early stop checker by counting the number of samples stops at different accumulator status c when N=11.

FIGS. 28-32 demonstrate results of experiments of this disclosure, and show that embodiments of this disclosure effectively reduce more than 250 ms latency and even improves the accuracy at the same time for N=11. After applying ADM adaptive early stop scheme, the majority of remaining error cases (0.33%) are the early detection case like gesture samples. If the same condition is used for early stop checker, the accuracy improves. If the condition for early stop checker is loosened, then the stop confirmation module can further reduce latency and improve or at least maintain the accuracy.

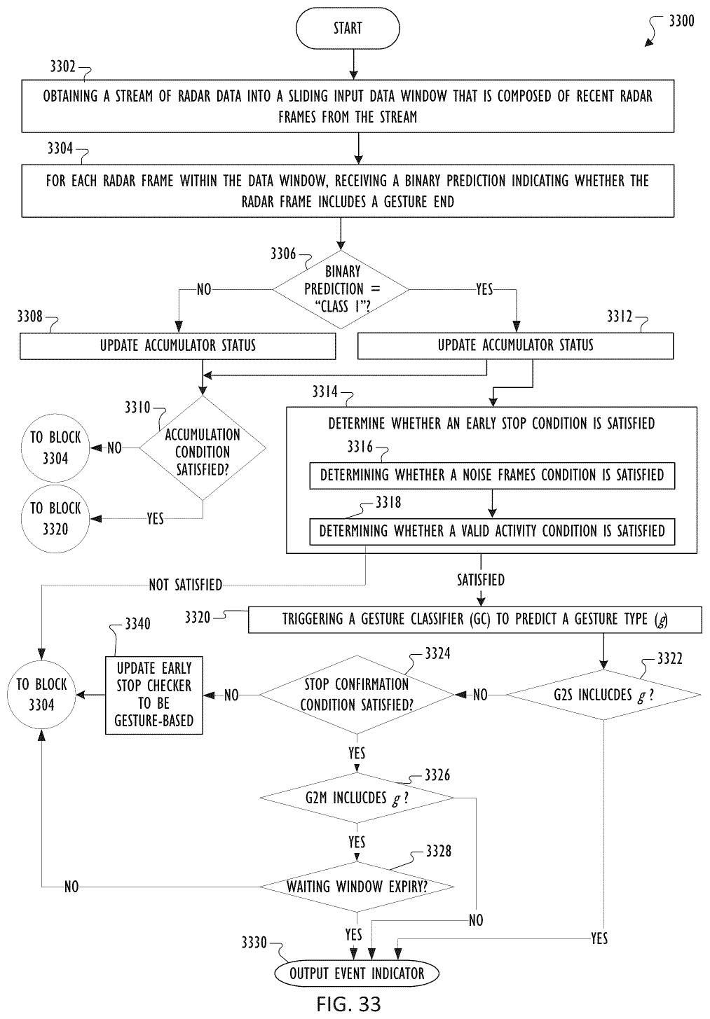

FIG. 33 illustrates a method 3300 for latency reduction in gesture recognition using mmWave radar in accordance with an embodiment of this disclosure. The embodiment of the method 3300 shown in FIG. 33 is for illustration only, and other embodiments could be used without departing from the scope of this disclosure. The method 3300 is implemented by an electronic device 200, and more particularly, performed by a processor 240 of the electronic device 200 that is operatively connected to a transceiver.

At block 3302, the processor 240 obtains a stream of radar data into a sliding input data window. The sliding input data window is composed of recent radar frames from the stream of radar data. Each radar frame within the data window includes features selected from a predefined feature set and at least one of time-velocity data (TVD) or time angle data (TAD).

At block 3304, for each radar frame within the data window, the processor 240 receives a binary prediction pᵢ indicating whether the radar frame includes a gesture end. At block 3306, the processor 240 identifies whether the received binary prediction includes an indicator of “class 1,” which is an indicator that the radar frame includes the gesture end.

At block 3308, in response to the binary prediction indicating that the radar frame does not the gesture end (for example, by including an indicator of “class 0”), the processor 240 updates an accumulator status c, and then the method 3300 proceeds to block 3310. At block 3310, the processor 240 (using an accumulator) determines whether an accumulation condition is satisfied. If the accumulation condition is not satisfied, then the method 3300 proceeds returns block 3304 to continue processing incoming radar frames. On the other hand, if the accumulation method is satisfied, then the method 3300 proceeds to block 3320 for triggering the GC 730 to predict a gesture type.

In response to the binary prediction indicating that the radar frame includes the gesture end, the processor 240 updates the accumulator status at block 3312 and triggers an early stop checker to determine whether an early stop condition is satisfied at block 3314. At block 3312, for each radar frame within the data window, the processor 240 obtains an accumulator status c. As an example, in FIG. 12, the early stop checker 1202 receives the accumulator status c from the accumulator 906. The accumulator status c is mapped to a lookback window size w and to a feature threshold (fₜₕ) that corresponds to each of the selected features.

At block 3314, in response to the binary prediction indicating that the radar frame includes the gesture end, the processor 240 triggers an early stop checker to determine whether an early stop condition is satisfied. Particularly, to determine whether the early stop condition is satisfied, the processor 240 determines whether a noise frames condition and a valid activity condition are satisfied at blocks 3316 and block 3318, respectively. The processor 240 determines that the early stop condition is satisfied based on a determination that both the noise frames condition and the valid activity condition are satisfied. In response to a determination that the early stop condition is not satisfied, the method 3300 returns to block 3304 to continue processing incoming radar frames.

In certain embodiments, the early stop checker, once triggered at block 3314, causes the processor 240 to determine, for each radar frame within the data window, whether the accumulator status c is equal to a multiple of a multiplier k for controlling periodicity of triggering the GC. The processor 240 skips triggering the GC 730, in response to a determination that the accumulator status c is not equal to a multiple of the multiplier k. On the other hand, the processor 240 triggers the GC 730 based (at least in part) on a determination that the accumulator status c is equal to a multiple of the multiplier k. The multiplier k can be a preset value.

At block 3316, the processor 240 determines the noise frames condition is satisfied when the lookback window of w recent radar frames in the data window are noise frames in which the selected features are less than the corresponding fₜₕ. If the noise frames condition is not satisfied, then the early stop condition is also not satisfied.

At block 3318, the processor 240 determines the valid activity condition is satisfied when the data window contains a valid activity. If the valid activity condition is not satisfied, then the early stop condition is also not satisfied.

At block 3320, in response to a determination that the early stop condition is satisfied, the processor 240 triggers a gesture classifier (GC) to predict a gesture type. The GC output 735 includes the gesture type predicted g.

At block 3322, the processor 240 determine whether to output an event indicator indicating that a user of an electronic device performed the gesture type predicted, based on whether the predicted gesture type is included within a subset of pause-free gestures (G2S), namely, the G2S set 762. That is, the processor 240 determines whether the predicted gesture type g is included within the subset of pause-free gestures (i.e., G2S set 762). In response to determining that the G2S set 762 includes the predicted gesture type g, the method 3300 proceeds to block 3330 at which the processor 240 outputs the event indicator without determining whether the stop confirmation condition is satisfied. In certain embodiments, the processor 240 additionally determines whether the GC output 735 includes a derived gesture length (l_{g}) that is in a specified range corresponding to the predicted gesture type g. The method 3300 proceeds from block 3232 to block 3330, in response to determining that the G2S set 762 includes the predicted gesture type g and that the l_{g} is within the specified range corresponding to the predicted gesture type g. On the other hand, in response to determining that the G2S set 762 does not include the predicted gesture type g, the method proceeds to block 3324.

At block 3324, the processor 240 determines whether a stop confirmation condition is satisfied by a GC output that includes the gesture type predicted g. The determination of whether a stop confirmation condition is satisfied represents a determination whether to output an event indicator indicating that a user of an electronic device performed the gesture type predicted g. In certain embodiments, in response to determining the stop confirmation condition is satisfied, the processor 240 outputs an indicator that the GC output satisfied the stop confirmation condition, and the method 3300 proceeds to block 3326. The indicator that the stop confirmation condition is satisfied is received by the G2M module 770. On the other hand, the processor 240, in response to determining the stop confirmation condition is not satisfied, the method 3300 proceeds to block 3340 and then returns to block 3304.

At blocks 3326-3328, in response to outputting the indicator that the GC output satisfied the stop confirmation condition, the processor 240 determines whether to wait for a waiting window to elapse prior to outputting the event indicator based on whether the predicted gesture type g is included within a subset of gestures (i.e., G2M set) that include a pause or repeat-motion. In response to a determination that the G2M set includes the predicted gesture type, the processor 240 triggers a waiting window and outputs the event indicator when the waiting window elapses. Particularly at block 3326, the processor 240 determines whether the whether the predicted gesture type g is included within a subset of gestures (i.e., G2M set) that include a pause or repeat-motion. In response to a determination that the G2M set does not include the predicted gesture type, the method proceeds to block 3330 at which the processor 240 outputs the event indicator without waiting for the waiting window to elapse. In response to a determination that the G2M set includes the predicted gesture type, the processor 240 triggers a waiting window, and the method proceeds to block 3328.

Particularly at block 3328, the waiting window has been triggered, and the processor 240 determines whether expiry of the waiting window has occurred. In response to a determination that the waiting window has not elapsed, the method returns to block 3304 for processing incoming radar frames. On the other hand, when the waiting window time period has elapsed, the method proceeds to block 3330. The procedure that the processor 240 performs at block 3330 can be the similar to or the same as the procedure performed at block 2608 of FIG. 26 or block 1908 of FIG. 19.

At block 3340, the processor 240 determines to not output the event indicator, updates the early stop checker by updating the noise frames condition and the valid activity condition to be gesture-based on the gesture type predicted tentatively, and continues (by returning the method 3300 to block 3304) to receive the binary prediction for each radar frame within an updated data window. Accordingly, in certain embodiments of block 3314, the processor 240, prior to determining whether the early stop condition is satisfied, determines whether the early stop checker is updated (for example, by determining whether the noise frames condition and the valid activity condition have been updated to be gesture-based). Based on a determination that the early stop checker is not updated, the processor 240 determines whether general versions of the noise frames condition and the valid activity condition are satisfied. Accordingly, in certain embodiments of block 3320, based on a determination that the early stop checker is updated, the processor 240 triggers the GC 730 to generate a subsequent GC output 735 that includes a subsequently predicted gesture type, in response to determining that the gesture-based noise frames condition and the gesture-based valid activity condition are satisfied.

Although FIG. 33 illustrates an example method 3300 for latency reduction in gesture recognition using mmWave radar, various changes may be made to FIG. 33. For example, while shown as a series of steps, various steps in FIG. 33 could overlap, occur in parallel, occur in a different order, or occur any number of times.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of this disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A method comprising:
obtaining a stream of radar data into a sliding input data window that is composed of recent radar frames from the stream, each radar frame within the data window including features selected from a predefined feature set and at least one of time-velocity data (TVD) or time angle data (TAD);
for each radar frame within the data window, receiving a binary prediction indicating whether the radar frame includes a gesture end;
in response to the binary prediction indicating that the radar frame includes the gesture end, triggering an early stop checker to determine whether an early stop condition is satisfied, wherein determining whether the early stop condition is satisfied comprises determining whether a noise frames condition and a valid activity condition are satisfied; and
in response to a determination that the early stop condition is satisfied, triggering a gesture classifier (GC) to predict a gesture type.

2. The method of claim 1, further comprising:
for each radar frame within the data window, receiving an accumulator status (c) that is mapped to a lookback window size w and to a feature threshold (fₜₕ) that corresponds to each of the selected features;
determining that the early stop condition is satisfied based on a determination that both the noise frames condition and the valid activity condition are satisfied;
determining the noise frames condition is satisfied when the lookback window of w recent radar frames in the data window are noise frames in which the selected features are less than the corresponding fₜₕ; and
determining the valid activity condition is satisfied when the data window contains a valid activity.

3. The method of claim 1, further comprising:
determining whether to output an event indicator indicating that a user of an electronic device performed the gesture type predicted, based on whether a stop confirmation condition is satisfied by a GC output that includes the gesture type predicted; and
in response to determining the stop confirmation condition is satisfied, outputting an indicator that the GC output satisfied the stop confirmation condition.

4. The method of claim 3, further comprising:
in response to determining the stop confirmation condition is not satisfied:
determining to not output the event indicator,
updating the early stop checker by updating the noise frames condition and the valid activity condition to be gesture-based on the gesture type predicted tentatively, and
continuing to receive the binary prediction for each radar frame within an updated data window;
prior to determining whether the early stop condition is satisfied, determining whether the early stop checker is updated;
based on a determination that the early stop checker is updated, triggering the GC to generate a subsequent GC output that includes a subsequently predicted gesture type, in response to determining that the gesture-based noise frames condition and the gesture-based valid activity condition are satisfied; and
based on a determination that the early stop checker is not updated, determining whether general versions of the noise frames condition and the valid activity condition are satisfied.

5. The method of claim 3, further comprising:
determining whether to output an event indicator indicating that a user of an electronic device performed the gesture type predicted, based on whether the predicted gesture type is included within a subset of pause-free gestures (G2S);
determining whether the GC output includes a derived gesture length (l_{g}) that is in a specified range corresponding to the predicted gesture type; and
in response to determining that G2S includes the predicted gesture type and that l_{g} is within the specified range, outputting the event indicator without determining whether the stop confirmation condition is satisfied.

6. The method of claim 3, further comprising:
in response to outputting the indicator that the GC output satisfied the stop confirmation condition, determining whether to wait for a waiting window to elapse prior to outputting the event indicator based on whether the predicted gesture type is included within a subset of gestures (G2M) that include a pause or repeat-motion;
in response to a determination that the G2M does not include the predicted gesture type, outputting the event indicator without waiting for the waiting window to elapse; and
in response to a determination that the G2M includes the predicted gesture type, triggering a waiting window and outputting the event indicator when the waiting window elapses.

7. The method of claim 1, further comprising:
for each radar frame within the data window, receiving an accumulator status (c); and
skipping triggering the GC based on a determination that the c is not equal to a multiple of a multiplier (k) for controlling periodicity of triggering the GC.

8. An electronic device comprising:
transceiver; and
a processor operatively connected to the transceiver, the processor configured to:
obtain a stream of radar data into a sliding input data window that is composed of recent radar frames from the stream, each radar frame within the data window including features selected from a predefined feature set and at least one of time-velocity data (TVD) or time angle data (TAD);
for each radar frame within the data window, receive a binary prediction indicating whether the radar frame includes a gesture end;
in response to the binary prediction indicating that the radar frame includes the gesture end, trigger an early stop checker to determine whether an early stop condition is satisfied, wherein determining whether the early stop condition is satisfied comprises determining whether a noise frames condition and a valid activity condition are satisfied; and
in response to a determination that the early stop condition is satisfied, trigger a gesture classifier (GC) to predict a gesture type.

9. The electronic device of claim 8, wherein the processor is further configured to:
for each radar frame within the data window, receive an accumulator status (c) that is mapped to a lookback window size (w) and to a feature threshold (fₜₕ) that corresponds to each of the selected features;
determine that the early stop condition is satisfied based on a determination that both the noise frames condition and the valid activity condition are satisfied;
determine the noise frames condition is satisfied when the lookback window of w recent radar frames in the data window are noise frames in which the selected features are less than the corresponding fₜₕ; and
determine the valid activity condition is satisfied when the data window contains a valid activity.

10. The electronic device of claim 8, wherein the processor is further configured to:
determine whether to output an event indicator indicating that a user of an electronic device performed the gesture type predicted, based on whether a stop confirmation condition is satisfied by a GC output that includes the gesture type predicted; and
in response to determining the stop confirmation condition is satisfied, output an indicator that the GC output satisfied the stop confirmation condition.

11. The electronic device of claim 10, wherein the processor is further configured to:
in response to determining the stop confirmation condition is not satisfied:
determine to not output the event indicator,
update the early stop checker by updating the noise frames condition and the valid activity condition to be gesture-based on the gesture type predicted tentatively, and
continue to receive the binary prediction for each radar frame within an updated data window;
prior to determining whether the early stop condition is satisfied, determine whether the early stop checker is updated;
based on a determination that the early stop checker is updated, trigger the GC to generate a subsequent GC output that includes a subsequently predicted gesture type, in response to determining that the gesture-based noise frames condition and the gesture-based valid activity condition are satisfied; and
based on a determination that the early stop checker is not updated, determine whether general versions of the noise frames condition and the valid activity condition are satisfied.

12. The electronic device of claim 10, wherein the processor is further configured to:
determine whether to output an event indicator indicating that a user of an electronic device performed the gesture type predicted, based on whether the predicted gesture type is included within a subset of pause-free gestures (G2S);
determine whether the GC output includes a derived gesture length (l_{g}) that is in a specified range corresponding to the predicted gesture type; and
in response to determining that G2S includes the predicted gesture type and that l_{g} is within the specified range, output the event indicator without determining whether the stop confirmation condition is satisfied.

13. The electronic device of claim 10, wherein the processor is further configured to:
in response to outputting the indicator that the GC output satisfied the stop confirmation condition, determine whether to wait for a waiting window to elapse prior to outputting the event indicator based on whether the predicted gesture type is included within a subset of gestures (G2M) that include a pause or repeat-motion;
in response to a determination that the G2M does not include the predicted gesture type, output the event indicator without waiting for the waiting window to elapse; and
in response to a determination that the G2M includes the predicted gesture type, trigger a waiting window and outputting the event indicator when the waiting window elapses.

14. The electronic device of claim 8, wherein the processor is further configured to:
for each radar frame within the data window, receive an accumulator status (c); and
skip triggering the GC based on a determination that the c is not equal to a multiple of a multiplier (k) for controlling periodicity of triggering the GC.

15. A non-transitory computer readable medium embodying a computer program, the computer program comprising computer readable program code that when executed causes at least one processor to:
obtain a stream of radar data into a sliding input data window that is composed of recent radar frames from the stream, each radar frame within the data window including features selected from a predefined feature set and at least one of time-velocity data (TVD) or time angle data (TAD);
for each radar frame within the data window, receive a binary prediction indicating whether the radar frame includes a gesture end;
in response to the binary prediction indicating that the radar frame includes the gesture end, trigger an early stop checker to determine whether an early stop condition is satisfied, wherein determining whether the early stop condition is satisfied comprises determining whether a noise frames condition and a valid activity condition are satisfied; and
in response to a determination that the early stop condition is satisfied, trigger a gesture classifier (GC) to predict a gesture type.

16. The non-transitory computer readable medium of claim 15, further comprising program code that when executed causes the at least one processor to:
for each radar frame within the data window, receive an accumulator status (c) that is mapped to a lookback window size w and to a feature threshold (fₜₕ) that corresponds to each of the selected features;
determine that the early stop condition is satisfied based on a determination that both the noise frames condition and the valid activity condition are satisfied;
determine the noise frames condition is satisfied when the lookback window of w recent radar frames in the data window are noise frames in which the selected features are less than the corresponding fₜₕ; and
determine the valid activity condition is satisfied when the data window contains a valid activity.

17. The non-transitory computer readable medium of claim 15, further comprising program code that when executed causes the at least one processor to:
determine whether to output an event indicator indicating that a user of an electronic device performed the gesture type predicted, based on whether a stop confirmation condition is satisfied by a GC output that includes the gesture type predicted; and
in response to determining the stop confirmation condition is satisfied, output an indicator that the GC output satisfied the stop confirmation condition.

18. The non-transitory computer readable medium of claim 17, further comprising program code that when executed causes the at least one processor to:
in response to determining the stop confirmation condition is not satisfied:
determine to not output the event indicator,
update the early stop checker by updating the noise frames condition and the valid activity condition to be gesture-based on the gesture type predicted tentatively, and
continue to receive the binary prediction for each radar frame within an updated data window;
prior to determining whether the early stop condition is satisfied, determine whether the early stop checker is updated;
based on a determination that the early stop checker is updated, trigger the GC to generate a subsequent GC output that includes a subsequently predicted gesture type, in response to determining that the gesture-based noise frames condition and the gesture-based valid activity condition are satisfied; and
based on a determination that the early stop checker is not updated, determine whether general versions of the noise frames condition and the valid activity condition are satisfied.

19. The non-transitory computer readable medium of claim 17, further comprising program code that when executed causes the at least one processor to:
determine whether to output an event indicator indicating that a user of an electronic device performed the gesture type predicted, based on whether the predicted gesture type is included within a subset of pause-free gestures (G2S);
determine whether the GC output includes a derived gesture length (l_{g}) that is in a specified range corresponding to the predicted gesture type; and
in response to determining that G2S includes the predicted gesture type and that l_{g} is within the specified range, output the event indicator without determining whether the stop confirmation condition is satisfied.

20. The non-transitory computer readable medium of claim 17, further comprising program code that when executed causes the at least one processor to:
in response to outputting the indicator that the GC output satisfied the stop confirmation condition, determine whether to wait for a waiting window to elapse prior to outputting the event indicator based on whether the predicted gesture type is included within a subset of gestures (G2M) that include a pause or repeat-motion;
in response to a determination that the G2M does not include the predicted gesture type, output the event indicator without waiting for the waiting window to elapse; and
in response to a determination that the G2M includes the predicted gesture type, trigger a waiting window and outputting the event indicator when the waiting window elapses.
